(19) United States
(12) Patent Application Publication
(10) Pub. No.: US 2025/0258457 A1
(43) Pub. Date: Aug. 14, 2025

(54) IMAGING DEVICES, APPARATUS, AND METHODS FOR THE DEVELOPMENT OF IMAGE RECORDING MEDIA

(71) Applicant: Polaroid International B.V., Amsterdam (NL)

(72) Inventors: Chi-Chan Chiang, Taipei City (TW); Keng-Hao Hsu, Hsinchu County (TW); Cheng-Chi Hu, Miaoli County (TW); Rong-Chang Liang, Cupertino, CA (US)

(21) Appl. No.: 18/439,465

(22) Filed: Feb. 12, 2024

(51) Int. Cl. G03G 15/00; G03G 15/22

(52) U.S. Cl. CPC G03G 15/6582; G03G 15/221; G03G 15/6558; G03G 15/6597

(57) ABSTRACT

Imaging devices, imaging apparatus, and methods are provided to improve the development of image recording media. The imaging devices comprise at least a pressing member and at least a first deformable pressure-receiving member. The pressing member is provided with a step feature which is pressed against the first deformable pressure-receiving member. As an image recording medium moves through between the pressing member with the step feature and the deformable pressure-receiving member, a corresponding step difference is formed on the medium where a distinct shear mechanism was experienced. The efficiency of image development is significantly improved as evident by the significant increase in the fresh optical density observed immediately after development even with a reduced applied force.

### TECHNICAL FIELD

The present disclosure relates to an image development device used in development and imaging equipment or apparatus, printers, copiers, instant cameras, or a combination of devices thereof. The device has a step feature therein. When an image recording medium or a radiation-sensitive, pressure-sensitive image recording medium such as a photosensitive microcapsule image recording medium, passes through, the step feature is used to bend the image recording medium, thereby generating a shear effect to reduce the applied force that causes the microcapsule thereof to break and improve the image development and image quality. More specifically, the present disclosure relates to an improved image development device, an improved imaging apparatus, and an improved method for the development of an image recording medium.

### BACKGROUND

Single sheet, self-containing, and full-color microcapsule imaging systems (such as Cycolor) have been developed from 1980s to 2000s (such as those disclosed by U.S. Pat. Nos. 4,399,209, 4,416,966, 4,440,846, 4,766,050, 5,783,353, and 5,916,727). The photosensitive microcapsule typically comprises a shell and a releasable photosensitive core or internal phase that comprises a photoinitiator or photosensitizer, a multifunctional acrylate and a leuco dye. After imaging exposure, the core of the microcapsule is selectively photo-hardened, and the leuco dye encapsulated therein immobilized through the polymerization/crosslinking of the multifunctional acrylate. The leuco dye in the unexposed or partially exposed microcapsules may be released through, for example, a pressure development mechanism, and react with a dye developer outside of the microcapsule to form a color positive image, wherein the color density decreases along with the increase of exposure energy or intensity.

In the prior art, high-pressure, enormous, and bulky pressure rollers (such as those disclosed by U.S. Pat. Nos. 4,727,392, 4,768,050, 4,819,032, 4,827,312, 5,208,609, and US Application Publication No. 2006/0029387A1) are typically required to develop an imaging medium (media sheet) with satisfactory color saturation and uniformity. When a very high pressure is used for development and imaging, a problem can often be observed that a lack of difference in rupture degree for microcapsule ruptures caused by the high pressure leads to obvious deterioration of the mid-tone and greyscale quality of the image.

On the other hand, when a lightweight, portable, and compact device is used for development and imaging, low color density and high image mottle or graininess that do not meet requirements are often observed since ruptures of the microcapsules are insufficient in quantity and are non-uniform. As the width of the imaging medium increases, the image quality further deteriorates. Generally speaking, the diameter and weight of the rollers must be increased, so as to ensure that the pressure applied to a roller is distributed evenly along the range of the entire roller. To pressurize the entire imaging medium in a uniform manner, expensive crowned rollers are typically required. However, as the size of the imaging medium increases, the cost, weight, and size of a pressure development device may all become excessively high to achieve satisfactory image quality of the developed images.

Devices that do not use bulky pressure rollers for image development are known. For example, the U.S. Pat. No. 4,448,516 discloses a developer roll that comprises an outer fibrous surface composed of interwoven natural or synthetic fibers or flexible bristles. In U.S. Pat. No. 4,578,340, an imaging medium passes through a bed of free particles or balls to rupture the microcapsules therein. In U.S. Pat. No. 4,592,986, an imaging medium is developed by means of contact and abrasion with magnetically attractable free particles on a magnetic brush when the imaging medium passes through or over them.

In addition, development of microcapsule imaging sheets with a rolling-ball, micro-wheels, a rotatable belt, etc., moving across the entire surface of the imaging sheet or web and the like have also been disclosed in, for example, U.S. Pat. Nos. 4,648,699, 4,824,755, 4,914,463, 5,546,154, 5,550,627, 6,034,712, and 6,963,392. In general, according to the above-described US patents, the imaging medium is secured to a cylinder, and the point contact is positioned in resilient pressure contact with the imaging medium. As the cylinder is rotated, the point contact is simultaneously moved along the cylinder in synchronism with the rotation of the cylinder to rupture the microcapsules and develop an image. Alternatively, the imaging medium may be mounted on a planar platform or a drum, and the point contact is moved across the surface of the imaging medium using, for example, an X-Y transport device or other moving devices to develop the image.

While these alternative solutions may be used for specific applications, the arrangement of each alternative solution has its trade-offs which were recognized by the inventors of the present application, and which are summarized as follows. For example, when an imaging medium was developed by a fibrous roller, non-uniform images are often obtained and the ingredients released from the ruptured microcapsules tend to accumulate in certain areas corresponding to the microstructure of the developer roller and result in a matte image or even an enhanced background color (or Dₘᵢₙ). In the solution that uses free particles and a magnetic brush, problems often observed include poor image uniformity due to non-uniform distribution of the released internal phase and leuco dye, and the noise generated by the moving parts. In the solution that uses the movement or rotation of a ball or sphere, the size of the sphere and the contact area can lead to problems including poor resolution and long developing time, and the back and forth movement of the rotating belt also causes undesirable noise and vibration, which may further cause defects such as straight stripes on the developed image. As recognized by the inventors of the present application, imaging devices are getting more compact and lighter in weight, and so new alternative solutions to develop high quality images are desired to overcome deficiencies of the prior art.

### SUMMARY

In view of the foregoing, the present disclosure provides an improved image development device for an image recording medium, more specifically a radiation-sensitive, pressure-sensitive image recording medium. The device is of a lower weight and a reduced size/footprint, and has the advantages of excellent developing quality, lowered applied force, reduced cost, and reduced noise and vibration during printing. The overall image quality of the developed images is also significantly improved with a higher color density, improved gray scale and uniformity with a lower image mottle and graininess.

The image development device according to an embodiment of the present disclosure comprises at least one pressing member and at least one (first) deformable pressure-receiving member, and the pressing member has a (first) step feature and presses against the at least one (first) deformable pressure-receiving member, such that the image recording medium, when passing between the pressing member and the at least one (first) deformable pressure-receiving member, is bent and may form a corresponding step difference and results in a significant improvement in the development of the imaging recording medium. Not to be bound by theory, it is believed that when a pressure, e.g., a normal pressure, is applied through the step feature on the at least one (first) deformable pressure-receiving member, a deformation or strain of the pressure-receiving member according to the (first) step feature is induced. As an image recording medium passes through between the pressing member and the (first) deformable pressure-receiving member, the medium may experience a high shear effect which results in an improved image development and image quality due to the improvements in the rupture of the microcapsules and spreading of the internal phase as well as the leuco dye(s) released therefrom. The applied pressure may be, but is not limited to, a normal pressure. The induced deformation or strain may be determined by the shortest distance between the pressing area of the pressing member and the outer diameter of the at least one (first) deformable pressure-receiving member after the image development device is assembled, and it may be, but is not limited to, between about 0.1 mm and about 1.5 mm, for example, between about 0.2 mm and about 1.2 mm or between about 0.3 mm and about 1.0 mm.

In one embodiment of the present disclosure, as the image recording medium passes through between the (first) deformable pressure-receiving member and the (first) pressing member comprising the step feature, a corresponding step difference is formed on the medium; which step difference may be, but is not limited to, between about 0.1 mm and about 1.5 mm, for example, between about 0.2 mm and about 1.2 mm or between about 0.3 mm and about 1.0 mm. Not to be bound by theory, it is believed that a high shear force is generated by means of this step difference, so as to significantly reduce the normal pressure or weight required to develop the image and enable a low noise and high-quality image development for compact and light weight imaging devices such as portable printers, and instant cameras.

In one embodiment of the present disclosure, as the image recording medium passes through between the (first) deformable pressure-receiving member and the (first) pressing member comprising a step feature, a corresponding deformation or strain is formed on the medium; which deformation or strain may be, but is not limited to, between about 1 and about 12.5 times of the thickness of the image recording medium, for example, between about 1 and about 10 times or between about 2.5 and about 8.3 times.

In one embodiment of the present disclosure, the at least one (first) deformable pressure-receiving member may be a roller or drum having an outer diameter which may be adjusted according to actual operational requirements, and the first step feature of the pressing member may comprise a first guiding-in area, a first pressing area, a first step area, and a first guiding-out area, but the present disclosure is not limited thereto; wherein the first step area may intersect with the first guiding-out area at an axis, but the present disclosure is not limited thereto; the shortest distance between the axis and the perpendicular line passing through the axle center of the first deformable pressure-receiving member is the first distance which may be, for example, but is not limited to, between greater than or equal to about 0.1 mm and smaller than or equal to about 1.5 mm, or between greater than or equal to about 0.2 mm and smaller than or equal to about 1.2 mm, or between greater than or equal to about 0.3 mm and smaller than or equal to about 1.0 mm. The shortest vertical distance between the axis or the first guiding-out area and the first pressing area of the pressing member is the second distance which may be, for example, but is not limited to, between greater than or equal to about 0.1 mm and smaller than or equal to about 1.5 mm, or between greater than or equal to about 0.2 mm and smaller than or equal to about 1.2 mm, or between greater than or equal to about 0.3 mm and smaller than or equal to about 1.0 mm. In another embodiment of the present disclosure the first deformable pressure-receiving member may have an outer diameter, and the first distance may be, for example, but is not limited to, between greater than or equal to about 0.01 times of the outer diameter and smaller than or equal to about 0.2 times of the outer diameter, or between greater than or equal to about 0.02 times of the outer diameter and smaller than or equal to about 0.15 times of the outer diameter, or between greater than or equal to about 0.04 times of the outer diameter and smaller than or equal to about 0.13 times of the outer diameter. The second distance may be, for example, but is not limited to, between greater than or equal to about 0.01 times of the outer diameter and smaller than or equal to about 0.2 times of the outer diameter, or between greater than or equal to about 0.02 times of the outer diameter and smaller than or equal to about 0.15 times of the outer diameter, or between greater than or equal to about 0.04 times of the outer diameter and smaller than or equal to about 0.13 times of the outer diameter. In another embodiment of the present disclosure the image recording medium may have a thickness, and the first distance may be, for example, but is not limited to, between greater than or equal to about 1 time of the thickness and smaller than or equal to about 12.5 times of the thickness, or between greater than or equal to about 2 times of the thickness and smaller than or equal to about 10 times of the thickness, or between greater than or equal to about 2.5 times of the thickness and smaller than or equal to about 8.3 times of the thickness; and the second distance may be, for example, but is not limited to, between greater than or equal to about 1 time of the thickness and smaller than or equal to about 12.5 times of the thickness, or between greater than or equal to about 2 times of the thickness and smaller than or equal to about 10 times of the thickness, or between greater than or equal to about 2.5 times of the thickness and smaller than or equal to about 8.3 times of the thickness. In another embodiment of the present disclosure, the first step area and the first guiding-out area may be connected to form an angle, and the angle thereof may be, for example, but is not limited to, between greater than or equal to about 90° and smaller than or equal to about 135°, or between greater than or equal to about 90° and smaller than or equal to about 120°, or between greater than or equal to about 60° and smaller than or equal to about 90°, or between greater than or equal to about 45° and smaller than or equal to about 90°, or equal to about 90°

In one embodiment of the present disclosure, the connection between the first pressing area and the first step area of the first step feature on the pressing member may have a rounded corner which may have a radius of curvature between, for example, but not limited to, about 0.1 mm and about 1.2 mm, or between about 0.1 mm and about 1 mm, or between about 0.1 mm and about 0.5 mm.

In one embodiment of the present disclosure, the image recording medium may have a thickness, and the connection between the first pressing area and the first step area of the first step feature of the pressing member may have a rounded corner which may have a radius of curvature between, for example, but not limited to, about 1 time and about 10 times of the medium thickness, or between about 1 time and about 8.3 times of the medium thickness, or between about 1 time and about 4.2 times of the medium thickness.

In one embodiment of the present disclosure, the deformable pressure-receiving member may be made of a soft material, but the present disclosure is not limited thereto. In one embodiment of the present disclosure, the deformable press-receiving member may comprise a core and an external layer, the external layer may cover the core, the core may be made of a hard material, and the external layer may be made of a soft material. The above-described hard material may be a metal (such as, copper, iron, aluminum, tin, nickel, lead, zinc, or an alloy thereof), thermoplastics or thermosets or their copolymers, blends or composites. The above-described soft material may be silicone rubber, nitrile butadiene rubber, polyurethane, ethylene-propylene-diene monomer, and the like, which is configured to bear a normal force and deform elastically. The Shore hardness (Shore A) of the soft material may be between about 10° and about 90°, between about 20° and about 80°, between about 30° and about 70°, or between about 40° and about 60°, but the present disclosure is not limited thereto.

In one embodiment of the present disclosure, the at least one pressing member may comprise a first pressing member and a second pressing member, the at least one deformable pressure-receiving member may comprise a first deformable pressure-receiving member and a second deformable pressure-receiving member, and the first pressing member and the second pressing member may be in contact with the first deformable pressure-receiving member and the second deformable pressure-receiving member, respectively, but the present disclosure is not limited thereto. In addition, the first pressing member and the second pressing member are similar to the above-described pressing member, and the first deformable pressure-receiving member and the second deformable pressure-receiving member are similar to the above-described deformable pressure-receiving member, which will thus not be described again herein. In one embodiment of the present disclosure, a heating device (a heater) may be further provided, and the heating device is arranged downstream of the pressing member, but the present disclosure is not limited thereto.

In one embodiment of the present disclosure, the deformable pressure-receiving member may be a soft transporting element (transporter) or an elastic transporting element, but the present disclosure is not limited thereto.

An image apparatus according to an embodiment of the present disclosure comprises at least one feeding device and the above-described image development device, wherein the feeding device is used for moving an image recording medium, and the image development device is arranged downstream of the at least one feeding device, but the present disclosure is not limited thereto. The image apparatus as described above may further comprise at least one heating device, and the heating device may be arranged downstream of the image development device, but the present invention is not limited thereto.

In one embodiment of the present disclosure, the heating device may comprise at least one heating element and at least one third deformable pressure-receiving member, the heating element may be arranged to be tightly attached to and in contact the third deformable pressure-receiving member, and the image recording medium moves to pass between the heating element and the third deformable pressure-receiving member, through which the heating element provides thermal energy to the image recording medium, so as to improve the efficiency of dye development and improve the image quality. In addition, the heating element may be a heating sheet, a heating film, a heating panel, or a heating roller, but the present disclosure is not limited thereto.

In one embodiment of the present disclosure, the third deformable pressure-receiving member is similar to the first deformable pressure-receiving member, and will thus not be described again herein, but the present disclosure is not limited thereto.

In one embodiment of the present disclosure, the heating element may further comprise a third step feature, its design is similar to the first step feature of the pressing member and will thus not be described again herein. Not to be bound by theory, it is believed that, as the image recording medium passes through the image development device, the internal phase as well as the leuco dye released from the ruptured microcapsules can be spread more rapidly and more uniformly by the use of the third step feature of the heating element. A faster rate of image development as well as an improved image quality can thus be achieved.

In one embodiment of the present disclosure, the image development device may comprise a plurality of pressing members, and the plurality of pressing members may be arranged coaxially or arranged to be staggered, but the present disclosure is not limited thereto.

In one embodiment of the present disclosure, the pressing member may be further provided with an additional second step feature of the same or similar design as the first step feature. As the image recording medium passes through between the deformable pressure-receiving member and the two consecutive step features of the pressing member, the number of ruptured or developed microcapsules and the degree and the uniformity of the microcapsule rupture may be significantly improved. It results in a significant improvement in the rate of image development as well as the image quality.

An imaging apparatus according to another embodiment of the present invention comprises at least an exposure device and the above-described image development device, wherein the exposure device is placed before the image development device. The exposure device may be a digital exposure device based on, for example, but is not limited to, light emitting diode (LED), organic light emitting diode (OLED), liquid crystal display (LCD), electroluminescent display (EL), organic electroluminescent display (OEL), plasma, and cold cathode fluorescent lamp (CCFL). The exposure device may also be an analogue exposure device exposing through a mask or a reflective image with a uniform flood light.

In one embodiment of the present disclosure, the imaging apparatus may be a printer, a copier, an instant camera, or a combination device thereof, but the present disclosure is not limited thereto.

In one embodiment of the present disclosure, the imaging apparatus may be a portable or handheld device or apparatus, but the present disclosure is not limited thereto.

Not to be bound by theory, the image development device according to the present disclosure can cause an image recording medium to bend according to the step feature and generate a high shear effect even with a low applied force. Such effect results in a more effective and more uniform rupture of the microcapsules in the image recording medium, and in turn a faster rate of image development with an improved image quality with a higher color saturation. The embodiments of the present invention allow the use of parts of lower weight, smaller size and lower cost, thereby enabling a high quality, portable and affordable imaging device or apparatus. Further, the noise generated by the operation of the imaging device or apparatus is also significantly reduced.

Another embodiment of the present disclosure is a method for forming an image on an image recording medium, the method comprising: image-wise exposing the image recording medium to a light or radiation; and causing the image recording medium to pass through the above-described image development device to rupture a plurality of microcapsules in the image recording medium, and developing to the corresponding image.

In addition, the image recording medium used in the present disclosure may be a pressure-sensitive image recording medium, a radiation sensitive pressure-sensitive image recording medium, or a microcapsule-based photosensitive image recording medium, but the present disclosure is not limited thereto. The image-recording medium may be a radiation sensitive image recording medium that is sensitive to any one or more of UV, near-IR and/or visible light. The radiation-sensitive image recording medium may also further be pressure-sensitive in addition to being sensitive to any one or more of UV, near-IR and/or visible light. The image recording medium used in the present disclosure comprises a substrate, a photosensitive microcapsule layer, and a top layer. The thickness of the image recording medium may be between, for example, but is not limited to, about 30 μm and about 1000 μm, between about 100 μm and about 800 μm, between about 150 μm and about 600 μm, or between about 200 μm and about 300 μm. The photosensitive microcapsule layer is disposed between the substrate and the top layer. The substrate may be selected from a list including, but is not limited to, polyethylene terephthalate (PET), polyethylene naphthalate (PEN), polybutylene phthalate (PBT), cellulose acetate, acrylics, polycarbonate, polyamide, polyimide, polysulfone, and their copolymers, blends or composites for protecting and supporting several other layers of the image recording medium. An opaque or white substrate such as Melinex 339 PET from DuPont Teijin Films may be used for a better image contrast and color saturation. The thickness of the substrate may be between, for example, but is not limited to, about 12 μm and about 250 μm or between about 25 μm and about 100 μm.

The above-described photosensitive microcapsule layer comprises a plurality of microcapsules (for example, thousands or millions of microcapsules). Each microcapsule in the photosensitive microcapsule layer comprises a shell and a core or internal phase comprising a leuco dye. The shell prevents the leuco dyes of different colors from being mixed together and enables the color separation required by full color reproduction. The shell may be made of a thermosetting or thermoplastic material through an interfacial polymerization/crosslinking process, an in situ polymerization process, a coacervation process, a phase separation process, or a combination thereof. The core or internal phase is microencapsulated by the shell and comprises at least a leuco dye and a radiation-sensitive material which is hardened or cured when exposed to radiation of a particular wavelength (for example, red light, green light, and blue light). The completely exposed or hardened microcapsules are hard to rupture under pressure, which can prevent the dye encapsulated therein from contacting the dye developer outside the microcapsules and reacting to form a visible image. The dye developer may be present in the same layer as the microcapsules or in a separate layer overcoated on or laminated with the microcapsule layer. On the contrary, an unexposed or partially exposed microcapsule shell remains rupturable or partially rupturable. Therefore, after pressurization, the degree of color development of the dye increases with the decrease of the exposure time or energy. As a result, the degree of rupture or the concentration of the release-able leuco dye of the microcapsules may be controlled to form a visible image of various color density by controlling the exposure time or energy of the image recording medium, thereby forming a color image with a greyscale or mid-tone color matched to the original image. The thickness of the photosensitive microcapsule layer may be, for example, but is not limited to, between about 5 μm and about 30 μm or between about 7 μm and about 15 μm.

The above-described top layer may be selected from the same list as that for the substrate for protecting and supporting other layers of the image recording medium. At least one of the two, the substrate and the top layer, must be of high transparency to the exposure radiation. A clear polyethylene terephthalate (PET) film can be used as the top layer for its high transparency in the visible light region, and superior mechanical and barrier properties against moisture and oxygen. The top layer may be laminated or overcoated onto the photosensitive microcapsule layer or the developer dye layer. The thickness of the top layer may be between about 4 μm and about 60 μm, between about 6 μm and about 36 μm, or between about 10 μm and about 25 μm, but the present disclosure is not limited thereto.

According to another aspect of the present disclosure the image recording medium may comprise a surface treatment layer or a primer layer, or both, disposed between the substrate and the microcapsule layer. A white primer layer on a white PET substrate is particularly useful to improve the adhesion between the microcapsule and the substrate, and to improve the reflectivity and hiding power of the image recording medium, which result in images of a better color saturation and color purity. In general, the thickness of the primer layer may be between about 0.5 μm and about 5 μm or between about 1 μm and about 3 μm, but the present disclosure is not limited thereto.

According to another aspect of the present disclosure the image recording medium may comprise a dye developer layer disposed between the photosensitive microcapsule layer and the top layer. Alternatively, a dye developer may be mixed with the microcapsules and coated on the substrate as a single layer. Upon contacting a leuco dye released from the microcapsules, the developer activates or reacts with the leuco dye to form a visible color image according to the amount and type of the ruptured microcapsules. The thickness of the dye developer layer, if disposed as a separate layer adjacent to the microcapsule layer, may be between about 2 μm and about 25 μm, between about 3 μm and about 15 μm, between about 4 μm and about 12 μm, or between about 5 μm and about 10 μm, but the present disclosure is not limited thereto.

According to another aspect of the present disclosure the image recording medium may be attached to a sticker on a release paper or liner, but the present disclosure is not limited thereto.

According to another aspect of the present disclosure the image recording medium may also be an instant film, but the present invention is not limited thereto.

The brief description of the present disclosure above is not intended to describe every disclosed implementation manner or every execution method according to the present disclosure. A person skilled in the art will be able to clearly understand the objectives, advantages, and novel features of the inventive concepts described herein according to the description of preferred embodiments below. However, said embodiments are not all of various different implementations of the present disclosure, and the enumeration thereof is only representative unless otherwise specified. Therefore, the scope of the present disclosure may be determined with reference to the scope of the present disclosure set forth in the claims appended to the description.

### BRIEF DESCRIPTION OF THE ACCOMPANYING DRAWINGS

FIG. 1 is a diagram of system architecture of an imaging apparatus (100) according to the present disclosure.

FIG. 2 is a cross-sectional view of an image recording medium (5) prepared according to Example 1 and Example 2 and used by an imaging apparatus (100) of the present disclosure. The image recording medium (5) comprises a substrate (51), a primer or surface treatment layer (52), a photosensitive microcapsule layer (53), a dye developer layer (54), and a top layer (55). The image recording medium (5) has been image-wise exposed and the microcapsules (531) therein may be unhardened (53a), or partially hardened (53b), or fully hardened (53c) according to the degree of exposure.

FIG. 3A is a cross-sectional view of a photo-printer, one of the embodiments of the imaging apparatus (100) built according to Example 3 of the present disclosure and FIG. 3B is a partially enlarged schematic drawing of the feeding device (2) (e.g., a feeding module), the image development device (4) (e.g., an image developer) and the heating device (3) assembled therein. FIG. 4A is a schematic view of a pressing member (41), a deformable pressure-receiving member (42) and an image recording medium (5) in the image development device (4) built according to Example 4 of the present disclosure; FIG. 4B is a schematic view of the assembled image development device (4) having an image recording medium engaged therein; and FIG. 4C is a 3-dimensional schematic view of a pressing member (41) used in the image development device.

FIG. 5 is a schematic view of another image development device (4a) according to Example 5 of the present disclosure.

FIG. 6A is a side view of another imaging apparatus (100b) comprising a feeding device (2b), an image development device (4b), and a heating device (3b) according to Example 6 of the present disclosure; and FIG. 6B is the schematic isometric view of FIG. 6A.

FIG. 7A is a schematic view of a heating device (3c) equipped with a heating element (31c) having a third step feature (311c) according to Example 7 of the present invention; and FIG. 7B is a 3-dimensional schematic view of the heating element (31c) of the heating device (3c).

FIG. 8 is a schematic view of another image development device (4d) according to Example 8 of the present disclosure.

FIG. 9A and FIG. 9B are schematic views of another two image development devices (4e and 4f, respectively) according to Example 9 of the present disclosure.

FIG. 10 is a schematic view of an assembly comprising a feeding device (2), another image development device (4g), and a heating device (3) according to Example 10 of the present disclosure.

FIG. 11 is a schematic view of a conventional roller image development device (94) used in Comparative Example 11-0 and Comparative Example 15-0-2.

FIG. 11-2 is a schematic view of a rolling-ball image development device (95) used in Comparative Example 15-0-1.

### DETAILED DESCRIPTION

Various embodiments of the present disclosure are provided below. These embodiments are used to describe technical content of the present disclosure instead of being used to limit the scope or claims of the present disclosure. One feature of one embodiment may be applied to other embodiments through proper modification, substitution, combination, and separation.

It should be noted that unless particularly specified, “deformable pressure-receiving member” herein refers to a deforming object that within the product life cycle, may recover to its initial state by substantially 100% (for example, about 99% or more, about 99.9% or more, about 99.5% or more, about 95% or more, or about 90% or more) after the pressure is released. Such an object can be elastomeric and can take the form of an annulus, for example.

It should be noted that unless particularly specified, a “guiding-in area” herein refers to the area where an incoming image recording medium is first engaged with the pressing member and guided into the image development device.

It should be noted that unless particularly specified, “pressing” herein refers to an action that a pressing member presses on a deformable pressure-receiving member and causes it to deform, and “pressing area” refers to the contact area between the two members.

It should be noted that unless particularly specified, a “turning area” or “step area” herein refers to the area where the image recording medium is forced to change its moving direction and deformed by the step feature.

It should be noted that unless particularly specified, a “guiding-out area” herein refers to the area on the pressing member where the image recording medium is guided out of the image development device. The “guiding-out area” may or may not physically contact with the deformable pressure-receiving member.

It should be noted that unless particularly specified, having “one” element herein is not limited to having only one of said element, but may have one or more of said elements.

In addition, unless particularly specified, ordinal numbers such as “first,” “second,” and the like herein are only used to differentiate a plurality of elements having the same name, and do not indicate that there is ranking, hierarchy, execution sequence, or process sequence among them. A “first” element and a “second” element may appear in the same member at the same time, or may appear in different members respectively. The presence of an element with a higher ordinal number does not necessarily mean the presence of another element with a lower ordinal number.

Unless particularly specified, so-called feature A “or” or “and/or” feature B herein refers to the presence of A only, the presence of B only, or the presence of both A and B; so-called feature A “and” feature B refers to the presence of both A and B; and so-called “comprising,” “including,” “having,” and “containing” refers to including certain elements but is not limited to.

In addition, unless particularly specified, terms such as “up,” “down,” or “between” herein are only used to describe relative positions of a plurality of elements and may be extrapolated in interpretation to situations including translation, rotation, or mirroring.

In addition, unless particularly specified, “an element is on another element” or a similar expression herein does not necessarily mean that this element contacts said another element.

In addition, unless particularly specified, “preferred” or “better” herein is used to describe an optional or additional element or feature, that is, these elements or features are not necessary but may be omitted.

In addition, unless particularly specified, a value herein may cover a range that is ±10% of the value, in particular a range that is within ±1%, ±2%, ±5% or ±10% of the value. Unless particularly specified, a value range is composed of a plurality of sub-ranges defined by a smaller end point number, a smaller quartile, a median, a greater quartile, and a greater end point number. As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 5% or plus or minus 10% of the particular value.

Before beginning to describe the drawings of some exemplary embodiments, it should be appreciated that the present disclosure is not limited to details or methods described in the description or illustrated in the accompanying drawings. It should be further appreciated that terms used herein are only used for the purpose of description and should not be regarded as limitations.

In brief, the present disclosure encompasses an improved image development device which is configured inside an imaging apparatus, and can receive a plurality of image recording media comprising photosensitive microcapsules. To form or reproduce an image, an imaging recording medium is image-wise exposed to light corresponding to an original image and cause the photosensitive microcapsules image-wise hardened or partial hardened or unhardened. Then, the image recording medium is sent into the image development device, and when passing between the pressing member and the deformable pressure-receiving member in the image development device, the image recording medium is bent and may form a corresponding step difference and generate a shear effect to facilitate the rupture of unhardened or partially hardened microcapsules to release the leuco dyes encapsulated therein to react with the dye developer and form an image according to the shape and color density of the original image. Then, the image recording medium may pass through a heating device, which provides thermal energy to improve the rate of the leuco dye/developer reaction and the rate of image development. The thermal energy also facilitates a more uniform dye distribution and mixing in the image recording medium and improves the image quality.

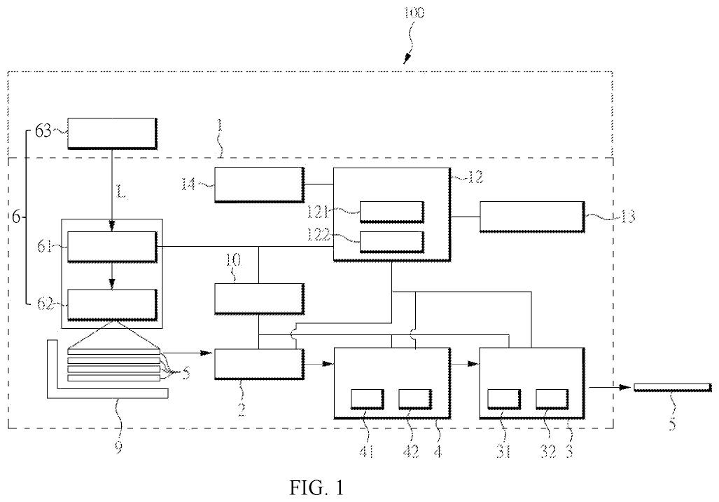

FIG. 1 is a diagram of system architecture of an imaging apparatus according to the present disclosure. As shown in FIG. 1, the imaging apparatus (100) according to at least one embodiment may be an image forming device, an image forming instrument, a camera, a printer, a copier, or a combination thereof. In some embodiments, the imaging apparatus (100) may also be an instant camera, an instant printer, or a combined apparatus of an instant camera and an instant printer.

The imaging apparatus (100) may receive one or more unexposed image recording media (5) or films. The imaging apparatus (100) may further comprise an exposure device (an exposer) (6) capable of exposing the image recording media (5) to one or more images to form a corresponding latent image or images. The latent image(s) is (are) then developed via a image development device (4) and a heating device (3) to form image(s) according to the input.

The imaging apparatus (100) may comprise a framework (1) (also referred to as a shell or structure) which comprises therein various parts that provide various functions of the imaging apparatus (100). As shown in FIG. 1, the framework (1) may combine, for example, a storage or container or sheet tray (9) in FIG. 1 capable of containing and supporting one or more sheets of the image recording medium (5) therein. The image recording media (5) may be, for example, in the form of a roll placed in the container or in the form of a sheet stacked on the sheet tray (9) or in other manner. In some embodiments, the sheet tray (9) may be movably connected (for example, slidably connected) to the framework (1), such that the sheet tray (9) may be slid out for addition of extra image recording media (5). In some embodiments, the slidably connected sheet tray (9) may be a disposable media box.

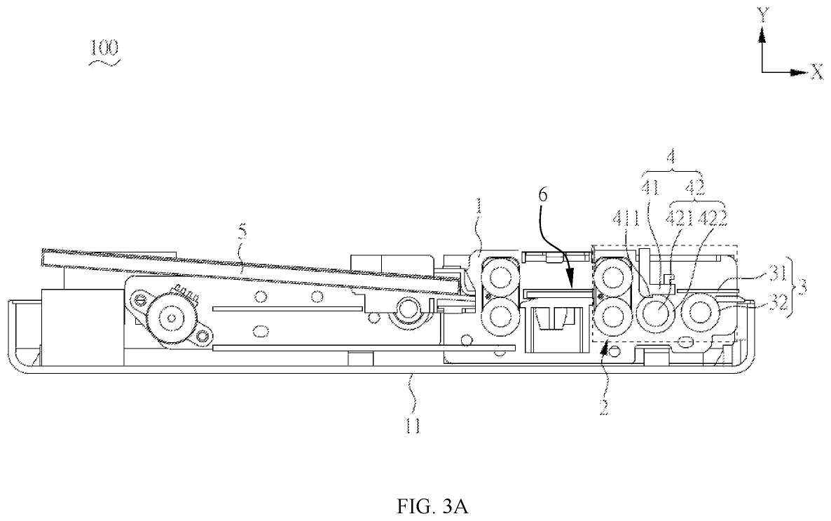

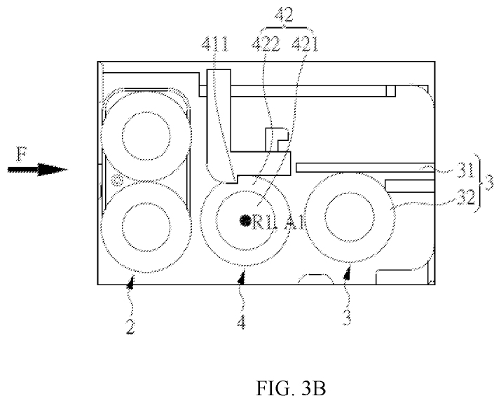

As shown in FIG. 3A, the imaging apparatus (100) of the present disclosure may comprise an exposure device (6) by which an image recording medium (5) may be exposed image-wise by the light (L) from a light source (63) (e.g., an exposure unit) to form a latent image on the medium. When the imaging apparatus (100) is an analog apparatus such as a camera or copier, the exposure light L may be the reflected light from the objects. to be imaged or copied. On the other hand, when the imaging apparatus (100) is a digital apparatus such as a printer, the exposure light (L) may be from a display, a monitor, or other adjustable artificial light sources such as a light emitting diode (LED), laser, organic light emitting diode (OLED), electroluminescent display (EL), organic electroluminescent display (OEL), liquid crystal display (LCD), plasma, cold cathode fluorescent display (CCFL), and the like, and an array thereof, which provides image light corresponding to the original image that a user desires to copy or print (for example, to be controlled by a smartphone, a tablet computer, a laptop computer, or a personal computer). The exposure light source (63) may be placed outside of the imaging apparatus (100) or included as a part inside the imaging apparatus (100) with for example, a controller (12). The controller (12) may be a microcontroller, a microcomputer, a microprocessor, or the like. In some embodiments, the controller (12) may include a processor and a memory which can be nonvolatile memory configured to store instructions therein, which, when executed by the processor, causes the controller (12) to carry out particular operations. Such operations can include operating the light source (63) to control turning on and turning off, and the duration and/or intensity of the light (L), for example.

The energy or intensity of the light (L) from the exposure light source (63) may be adjusted by the aperture, color filter, or shutter in an exposure limiter (61) of an exposure device (6). For example, the exposure limiter (61) may comprise a shutter that selectively prevents the light (L) from being transmitted from the exposure light source (63) to the image recording media (5). Alternatively, the exposure limiter (61) may comprise an aperture or color filter that filters or reduces the amount of light transmitted from the exposure light source (63) to the image recording medium (5).

The light L passing through the exposure limiter (61) may selectively pass through one or more optical elements or devices, such as a lens array (62) which may comprise one or more optical elements (for example, lenses, mirrors, apertures, and the like) to re-direct or change the light (L) transmitted from the exposure limiter (61) to the image recording medium 5. The lens array (62) may re-direct, filter, or change in other manners the light L, such that it passes and is projected to the image recording medium (5), such that the image recording medium 5 exposes a desired image. In some embodiments, the exposure device (6) may expose only one sheet of the image recording media (5) within a given period of time, which can be favorable for exposing each of the image recording media (5) sequentially to different images.

In some embodiments of the present disclosure, after the exposure, the exposed image recording medium (5) may be moved away from the sheet tray (9) via a feeding device (2) as shown in FIG. 1, such as a driver, a transporting machine (conveyor, transporter), or a roller device. The feeding device (2) may drive the exposed image recording medium (5) until the exposed image recording medium (5) exits the framework (1). Alternatively, the feeding device (2) may only drive the exposed image recording medium (5) to a next device of the imaging apparatus (100), such as the image development device (4). In some embodiments, the feeding device (2) comprises one or more rollers to receive and/or transport forward the exposed image recording medium (5). In some embodiments, the imaging apparatus (100) comprises a driver or an electric motor (10), which is connected to and drives the feeding device (2). In some embodiments, the motor or driver (10) is connected to the feeding device (2) via a transmission device such as a gear train.

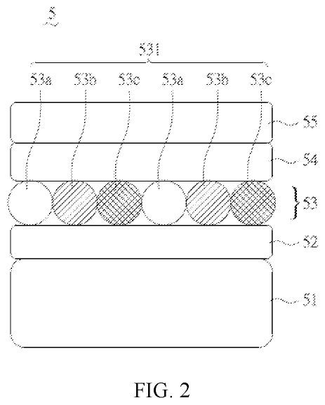

The feeding device (2) transports the exposed image recording medium (5) to the image development device (4) that is connected to the framework (1). Not to be bound by any theory, it is believed that as the exposed image recording medium (5) passes through the image development device (4), a high shear effect is generated inside the exposed image recording medium (5). This shear effect causes microcapsules (531) of the image recording medium (5) (as shown in FIG. 2) to rupture more easily. The degree of microcapsule rupture and in turn the color density of the developed image is a function of the degree of exposure. In some embodiments, the image development device (4) comprises one or more rollers for transporting the exposed image recording medium (5) to for example, the heating device (3). The above-described rollers may be driven by one or more motors (10). In some embodiments, the imaging apparatus (100) may comprise more than one image development device (4), to further improve the efficiency of the capsule rupture as well as image development even when the applied force or pressure is further reduced. The reduction of the applied force not only allows for the use of lighter parts, but also can make the apparatus more energy efficient.

After the image-wise exposed image recording medium (5) passes the image development device (4), the microcapsules (531), particularly the unhardened (53a) and partially hardened (53b) microcapsules in the image-wise exposed image recording medium (5), as shown in FIG. 2, are ruptured with various degrees of rupture to release the leuco dyes encapsulated therein to develop the image according to various degrees of exposure. The exposed and ruptured image recording medium (5) then passes through a heating device (3) as shown in FIG. 1, which is connected to the framework (1). The heating device (3) may comprise one or more heating elements (31) that provide thermal energy to improve the rate and efficiency of the dye development and facilitate a better distribution and mixing of the dyes in the image recording medium (5). The heating elements (31) may be, for example, but are not limited to, resistance heating elements including resistors. In some embodiments, the heating device (3) may comprise one or more heating rollers, which transport the developed image recording medium (5) and send it out of the framework (1). These rollers may be driven by the motor (10) or another motor.

In some embodiments, the imaging apparatus (100) comprises a controller (12) or a processing circuit, which controls the operations of the imaging apparatus (100). The controller (12) comprises a processor (121) and a memory (122) as an example of a storage device as shown in FIG. 1. The memory (122) may comprise one or more instructions executed by the processor (121) to execute one or more processes described herein. The controller (12) may be operably connected to the exposure limiter (61), the feeding device (2), the image development device (4), and/or the heating device (3) and control their operations. For example, the controller (12) may provide information or data, and send commands to the exposure light source (63), the exposure limiter (61), the feeding device (2), the image development device (4), and/or the heating device (3). In some embodiments, the controller (12) may receive information or data (for example, sensor data or operating states) from the exposure limiter (61), the feeding device (2), the image development device (4), and/or the heating device (3).

Hardware and data processing components used to implement the various processes, operations, and/or modules described in connection with the embodiments disclosed herein and in particular to any controller capability may be implemented, include, or be performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A processor also may be implemented as a combination of computing devices, such as a combination of a DSP and a microprocessor, a plurality of microprocessors, one or more microprocessors in conjunction with a DSP core, or any other such configuration, and may include one processor or multiple processors which are configured to collectively carry out the specified operations. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) one or more processes described herein.

In some embodiments, the imaging apparatus (100) comprises one or more input apparatuses and/or output apparatuses (labeled as a user interface (14) in FIG. 1). The user interface (14) is operably coupled to the controller (12) and configured to facilitate communications between a user and the controller (12). The user may use the user interface (14) to control operations of the imaging apparatus (100) (for example, starting to form an image on the image recording medium (5)). The user interface (14) may comprise one or more input devices, such as a button, a key, a keypad, a stylus, a switch, a joystick, a knob, a microphone, or a touchscreen, which helps the user transmit information (for example, a command) to the controller (12). The user interface (14) may comprise one or more output devices, such as a display, a lamp, a speaker, an audiovisual output, and/or a haptic feedback device, which helps, for example, transmit information regarding the current state of the imaging apparatus (100), troubleshooting information, and the like to the user via the controller (12).

In some embodiments, the imaging apparatus (100) comprises an energy supply or energy storage device (labeled as a power source (13) in FIG. 1), which is configured to supply energy or power to various devices in the imaging apparatus (100). The power source (13) may be operably coupled to the controller (12). In some embodiments, the controller (12) may control electric energy from the power source (13) to various systems or devices of the imaging apparatus (100) (for example, the exposure limiter (61), the motor (10), the image development device (4), and the heating device (3)). In other embodiments, the power source (13) directly supplies power to various devices or systems of the imaging apparatus (100). The power source (13) may comprise one or more energy storage devices, for example, a battery or a capacitor. In other embodiments, the power source (13) may be connected to an external power source, for example, a power grid, a power utility, etc.

### Image Development Procedure

Referring to FIG. 1 and FIG. 2, to produce or reproduce an image, an image recording medium (5) is image-wise exposed to the light (L) from the light source (63) according to a desired original image. The light (L) passes through a top layer (55) and a dye developer layer (54) and exposes the photosensitive microcapsule layer (53), thereby hardens a subset of the microcapsules (531) via the polymerization or crosslinking of the internal phase encapsulated therein. Each microcapsule (531) corresponds to a part of the image. Therefore, the energy and wavelength or color of the light received by each microcapsule (531) will determine whether the microcapsule (531) is selectively unhardened (53a), or partially hardened (53b), or fully hardened (53c). A latent image comprising various patterns and distribution of unhardened (53a), partially hardened (53b), and fully hardened (53c) microcapsules (531) is formed by the image-wise exposure. The latent image is then developed by the image development device (4) to form an image on the image recording medium (5) with the shape, position, color, and brightness or saturation of the image corresponding to the original image.

After the exposure, the image recording medium (5) is transported into the image development device (4) by for example, the feeding device (2). When the image recording medium (5) passes through the image development device (4), the step feature in the image development device (4) causes the image recording medium (5) to bend, thereby generates a shear effect on the microcapsules (531). As a result, the unhardened (53a) and partially hardened (53b) microcapsules (531) can be ruptured more easily with a lower applied force to release the leuco dye(s) encapsulated therein to form a color image by reacting with the dye developer(s) outside the microcapsules. In contrast, the fully photo-hardened microcapsules (53c) are able to resist this shear effect and remain un-rupturable by the image development device (4), and as such, the leuco dye(s) encapsulated therein remain non-developable.

The thus developed image recording medium (5) may then be heated by the heating elements (31) of the heating device (3). A proper thermal energy from the heating elements (31) may increase the reaction rate between the leuco dye(s) and the developer(s), and increase the rate of image development. Moreover, the heating also facilitates a faster and more uniform dye diffusion, distribution and mixing in the image recording medium (5), more specifically in the dye developer layer (54), and results in improvements in the image fidelity and quality, including the color density, color saturation and uniformity.

Optical density is one of the most common criteria for evaluating an image recording medium (5). The color saturation of a developed image in general increases with an increase in the maximum achievable optical densities (Dₘₐₓ) of the three substrative primaries, cyan, magenta and yellow of the image recording medium (5). As illustrated in the Examples described hereafter, it was found that a proper increase of the step difference of the step feature in the image development device (4) effectively resulted in a dramatic increase of the shear effect experienced by the image recording medium (5) even with a significantly reduced applied force. It in turn resulted in a significant improvement in the degree of capsule rupture as well as the fresh maximum optical density (D_{max,fresh}) (that is, the maximum optical density measured immediately after the development) and the color saturation of the developed image on the image recording medium (5), and improving color saturation and the image quality.

### Structure of an Image Recording Medium

FIG. 2 is a cross-sectional view of an image recording medium (5) used by an imaging apparatus (100) according to at least one embodiment of the present disclosure. The image recording medium (5) may be any pressure-sensitive photosensitive medium (e.g., a pressure-sensitive image recording medium) including, but is not limited to a photosensitive microcapsule medium, an instant imaging medium (instant film) and the like. The image recording medium (5) may be used together with the imaging apparatus (100) according to at least one embodiment of the disclosure as shown in FIG. 1. The image recording medium (5) comprises stacked layers of different materials as shown in FIG. 2, and each stacked layer is used for a different purpose, so as to facilitate the provision of high quality and durable images on the image recording medium (5). Although specific arrangements of various layers are illustrated in FIG. 2, it should be appreciated that the imaging apparatus (100) may be used together with various image recording medium of various numbers of layers of different materials, microstructures, morphologies, arrangements, or dimensions.

As shown in FIG. 2, an image recording medium (5) of the present disclosure comprises a substrate (51), a primer or surface treatment layer (52), a photosensitive microcapsule layer (53), a dye developer layer (54), and a top layer (55), wherein the photosensitive microcapsule layer (53) is disposed between the substrate (51) and the top layer (55) and comprises a plurality of microcapsules (531) including for example, blue-sensitive, green-sensitive, and red-sensitive microcapsules or their various combinations. Accordingly, the image recording medium (5) may be a microcapsule-based photosensitive image recording medium. The primer or surface treatment layer (52) is disposed between the substrate (51) and the photosensitive microcapsule layer (53), and the dye developer layer (54) may be disposed between the photosensitive microcapsule layer (53) and the top layer (55).

In some embodiments of the present disclosure, the image recording media (5) have a total thickness between, for example, but is not limited to, about 25 μm and about 200 μm. The substrate (51) is for example, a white polyethylene terephthalate (PET) film from DuPont Teijin Films with a thickness between about 25 μm and about 100 μm, to protect and support other layers of the image recording medium (5), and is selected to form an image with maximized image quality and durability. The primer or surface treatment layer (52) may be a highly reflective white coating with a thickness of about 1.0 μm to 5.0 μm or a thin layer of surface treatment agent with a thickness of about 0.01 μm to about 1.5 μm. It improves the adhesion between the photosensitive microcapsule layer (53) and the substrate (51) and/or improves the rigidity and hiding power and in turn the image quality of the image recording medium (5). In some embodiments, both a primer layer and a surface treatment layer may be employed. In other embodiments, a plasma or corona treatment may be employed before each coating to further improve the layer-to-layer adhesion.

In one of the embodiments, the photosensitive microcapsule (531) comprises a polymeric shell which encapsulates therein a photosensitive core or internal phase comprising a photoinitiator or sensitizer, a multifunctional polymerizable or crosslinkable monomer such as a multifunctional acrylate or vinyl, and a leuco dye. The particle size of the microcapsules may be between about 2 μm and about 15 μm, preferably between 4 μm and about 10 μm. Microcapsules having too high a particle size may result in a poor handleability and may be ruptured prematurely to form undesirable color defects. On the other hand, microcapsules having too small a particle size may require excessively high applied force to rupture and result in images of a low color density and poor color saturation. The total thickness of the microcapsule layer may range from 3 μm to about 30 μm, preferably between about 4 μm to about 15 μm, more preferably between about 5 μm to about 12 μm. A microcapsule layer having too high a thickness may result in a poor photo-exposure in the lower part of the layer in turn a poor Dₘᵢₙ (the minimum achievable color density or the background color density of an image). On the other hand, too thick a microcapsule layer may also result in a poor integrity of the layer and as such, the image recording medium thus forms may be delaminated easily due to the cohesion failure within the microcapsule layer. For a full-color image recording medium, the photosensitive microcapsules layer may comprise a mixture of, for example, blue-sensitive microcapsules with a yellow leuco dye encapsulated therein, a green-sensitive microcapsules with a magenta leuco dye encapsulated therein, and red-sensitive microcapsules with a cyan leuco dye encapsulated therein. In some embodiments, the image recording medium (5) may comprise microcapsules containing dyes of other colors. For example, the image recording medium (5) may be configured to a monochrome film that forms a black and white image. In this type of embodiments, each microcapsule (531) may contain a black leuco dye or a mixture of leuco dyes of various colors to form a black color after developed by a dye developer, and the core or internal phase of the microcapsule (531) may be configured to be hardened when exposed to visible light or other radiation (for example, UV and near-IR light). Accordingly, the image recording medium (5) may be a radiation-sensitive, pressure-sensitive image medium.

In the other embodiment, the dye developer layer (54) comprises a developer and has a thickness of about 4 μm to about 15 μm, which may activate or react with, upon contacting a leuco dye from one or more microcapsules (531) to form a visible color image. In another embodiment, the dye developer layer (54) and the photosensitive microcapsule layer (53) may be mixed and coated as a single layer. In some embodiments, the top layer (55) is a clear polyethylene terephthalate (PET) film with a thickness of about 4 μm to about 50 μm and is used as a cover to protect and support other layers of the image recording medium (5). At least one of the top layer and the substrate must be transparent to allow the light (L) from the exposure light source (63) to enter the image recording medium (5) and image-wise harden the photosensitive microcapsules therein (as shown in FIG. 2). A thin and optical clear top layer is favorable to minimize the potential light scattering and facilitate the formation of a high-resolution and high-contrast image. In some embodiments, the top layer may be laminated or overcoated onto the other layers. In some embodiments, the image recording medium (5) may be attached to a sticker with a release liner. However, the present disclosure is not limited thereto, and the thicknesses and materials of various layers of the image recording medium (5) may be adjusted as needed.

For purposes of the present disclosure, the term “color density” refers to a developed dye's reflective optical density or the ability to reflect light from the media sheet, as measured by a reflective Spectrodensitometer FD-5 from Konica Minolta, where the greater the dye's light reflection, the higher the color optical density (i.e., the more intense the color). The lower the dye's light reflection, the lower the color density (i.e., the less intense the color).

For purposes of this disclosure, the term “leuco dye” refers to a chemical dye which can alternate between two chemical forms, one of which is colorless. The transformation from the colorless leuco form to the color dye form may be reversible or irreversible and may be induced by changes in temperature, pH, irradiation, or redox state.

For purposes of this disclosure, the term “maximum color density” (or “Dₘₐₓ”) and “minimum color density” (or “Dₘᵢₙ”) refers to the maximum color density achieved by a dye after a given development time as measured by a reflective Spectrodensitometer FD-5 from Konica Minolta (e.g., “D_{max,fresh}” or “fresh Dₘₐₓ” refers to the maximum color density of the developed image sheet as measured immediately after development, and “D_{max,t}” refers to the maximum color density as measured after the developed image sheet is conditioned for a period of time, t. The term “minimum color density” (or “Dₘᵢₙ”) refers to the minimum reflective color optical density measured in the non-image area.

For purposes of this disclosure the term “opaque” means having a total light transmittance (TLT) of less than 20%, less than 10%, less than 9%, less than 8%, less than 7%, less than 6%, less than 5%, less than 4%, less than 3%, less than 2%, or less than 1%, as measured according to ASTM D1003.

For purposes of this disclosure, the term “white substrate” means a substrate having a whiteness index of at least about 90%, at least about 92%, at least about 95%, at least about 96%, at least about 97%, at least about 98%, at least about 99%, at least about 99.5%, or greater, as measured according to ASTM E313-79. In some embodiments, the second substrate has a whiteness index of 100%, as measured by ASTM E313-79.

Unless explicitly indicated otherwise, all specified embodiments, features, and terms intend to include both the recited embodiment, feature, or term and all equivalents thereof. Reference will now be made in detail to some specific embodiments contemplated by the present disclosure. While various embodiments are described herein, it will be understood that it is not intended to limit the present technology to the described embodiments. On the contrary, it is intended to cover alternatives, modifications, and equivalents as may be included within the spirit and scope of the technology as defined by the appended claims.

### EXAMPLES

### Example 1 Preparation of the Photosensitive Microcapsule Layer (53) and the Dye Developer Layer (54)

### Example 1-1 Preparation of Photosensitive Microcapsules (531)

The microcapsules (531) used in the photosensitive microcapsule layer (53) as shown in FIG. 2 were prepared in a dark room by for example, adding 220 g of D.I. water and 8 g of dry Versa TL502 (sulfonated polystyrene) into a 1000 mL stainless steel beaker with a thorough mixing; slowly adding 10 g of pectin (polygalacturonic acid methyl ester) into the mixture, and stirring at 500-1000 rpm and room temperature for overnight; using a 10 wt. % solution of sodium carbonate to adjust the pH to 7.5, and increasing the mixing speed to 1750 rpm; adding the internal phase as shown in Table 1 below within 15 to 30 seconds, stirring for 30 minutes, adding 11 g of a 9.1 wt. % aqueous solution of DETA (diethylenetetramine) with pH adjusted to 7.0, reacting at 25° C. for 30 minutes after the addition, and then reacting at 40° C. for 1 hour; adding a solution containing 19.9 g of CYMEL®385 and 40 g of D.I. water and adjusting the pH to 6.0, and heating the reaction mixture at 70° C. for 2 hours; adding 15.23 g of a 34.3 wt. % aqueous solution of sodium sulfate, stirring for 10 minutes, then adding 1.97 g of CYMEL® 385 and 10 g of D.I. water, and further reacting at 70° C. for 1 hour; lowering the mixing speed to 600 rpm, adjusting the pH of the reaction mixture to 9.5 by a 20 wt. % aqueous solution of NaOH, and stirring the reaction mixture at room temperature for overnight to obtain the photosensitive microcapsules (531) of one or more embodiments of the present disclosure.

TABLE 1
A typical internal phase used for the
preparation of microcapsules (531)

| Ingredients | dry weight | |
|---|---|---|
| TMPTA (trimethylolpropane triacrylate) | 90.00 | g |
| TPGDA (tripropylene glycol diacrylate) | 10.00 | g |
| THEED (N,N,N′,N′-tetrakis(2-hydroxyethyl)ethylenediamine) | 0.20 | g |
| DIDMA (2,6-diisopropyl-N,N-dimethylaniline) | 3.00 | g |
| Irganox ® 1035 | 0.10 | g |
| Magenta Leuco Dye (CAS: 50292-95-0) | 20.00 | g |
| MTBS (mercaptobenzothiazole disulfide) | 0.500 | g |
| Green photosensitive initiator (1-heptyl-2-[3-(1-heptyl-3,3- | 0.075 | g |
| dimethyl-1,3-dihydro-2H-indol-2-ylene)- propenyl]-3,3- | | |
| dimethyl-3H- indol isobutyltriphenylborate) | | |
| Desmodur ® N 100 | 8.00 | g |
| DBTDL (dibutyltin dilaurate) | 0.050 | g |

The microcapsules (531) thus obtained were washed thoroughly with D.I. water and centrifuged to remove the excess water-soluble polymers and additives in the aqueous phase. The wash-centrifuge procedure was repeated several times. The microcapsules (531) thus prepared showed an average size of about 5.8 μm with a PDI (particle size distribution index) of about 1.40, as measured with a HORIBA LA-960 laser particle size analyzer. The procedure for the preparation of the green-sensitive microcapsules comprising a magenta leuco dye was illustrated here as an example. A similar procedure was used for the preparation of microcapsules of other colors (for example, blue-sensitive microcapsules with a yellow leuco dye and red-sensitive microcapsules with a cyan leuco dye), except that the photoinitiator and leuco dye were different.

### Example 1-2 Preparation of the Photosensitive Microcapsule Coatings (53)

D.I. water was added to the coating composition as shown in Table 2 below to prepare a coating fluid having a solid content of 33 wt %. The fluid was then coated on a 50 μm white PET (Melinex 339) substrate (51) by a doctor blade, and dried in an 80° C. oven for 10 minutes. The dry coating thickness was about 8 μm as measured by a Mitutoyo thickness gauge.

TABLE 2
Composition of a typical photosensitive microcapsule coating (53)

| | Parts by |
|---|---|
| Ingredients | weight |
| Microcapsule fluid (solid content of 45%) | 100.00 |
| GSB1202 (solid content of 50%) (particle size, D₅₀ = 11.44 um) | 2.50 |
| CaCO₃ (solid content of 33%) (particle size, D₅₀ = 0.12 um) | 5.00 |
| CELLOSIZE ™ QP-52000H | 1.07 |
| AEROSOL ™ OT | 0.05 |
| TRITON ™ X-114 | 0.05 |
| Silwet L *-7001 | 0.20 |
| Silwet L *-7604 | 0.20 |
| TAMOL ™ 731 DP | 2.00 |
| M35 latex adhesive | 9.00 |
| FOAMSTAR ® ST 2410 | 0.25 |

### Example 1-3 Preparation of the Dye Developer Layer (54)

The developer composition as shown in Table 3 below was coated with a Myrad rod on a clear PET film having a thickness of 12 μm to 25 μm as the top layer (55) and dried in an 80° C. oven for 10 minutes. The dry coating thickness was about 9 μm as measured with a Mitutoyo thickness gauge.

TABLE 3
Composition of a typical dye developer coating (54)

| Ingredients | Parts by weight |
|---|---|
| RD9870A | 98.00 |
| CAB-O-SPERSE ® 1015A | 0.86 |
| PVA1799 | 1.14 |

### Example 2 Preparation of the Image Recording Medium (5)

The dye developer coating (54) on the top layer (55) thus prepared was laminated with the photosensitive microcapsule layer (53) on the substrate (51) with a Tamerica roll laminator TCC2700 with the temperature, pressure, and speed set at 100° C., 3.621 Kgf/170 mm, and 0.368 m/min, respectively, so as to form the image recording medium (5). All the procedures described above were carried out in a proper dark room to avoid any premature hardening of the photosensitive microcapsules.

### Example 3 Preparation of an Imaging Apparatus (100)

FIG. 3A shows a photo-printer, one of the embodiments of the imaging apparatus (100) built according to the present disclosure comprising a framework (1), a feeding device (2), a heating device (3), an image development device (4), an image recording medium (5), and an exposure device (6). The feeding device (2), the heating device (3), the image development device (4), and the exposure device (6) were assembled onto the framework (1) with a stack of image recording media (5) inserted and engaged therein. The image development device (4) which comprises a pressing member (41) such as a press or a pressurizer, and a first deformable pressure-receiving member (42) (e.g., a deformable pressed member), was disposed between the feeding device (2) and the heating device (3). FIG. 3B shows a partially enlarged schematic drawing of the feeding device (2), the image development device (4) and the heating device (3) assembled in the imaging apparatus (100) with the medium moving direction (F) also marked.

### Example 4 Preparation of an Image Development Device (4)

FIG. 4A shows a schematic view of a pressing member (41), a deformable pressure-receiving member (42) and an image recording medium (5) in the image development device (4) built according to Example 4; FIG. 4B shows a schematic view of the assembled image development device (4) having an image recording medium engaged therein; and FIG. 4C is a 3-dimensional schematic view of a pressing member (41) used in the image development device.

As shown in FIG. 4B, the pressing member (41) comprising a first step feature (e.g., a first step, a first step difference feature) (411) was assembled to press against the first deformable pressure-receiving member (42) and form a first step difference deformation (4221) on the pressure-receiving member (42). The deformation or the strain is the shortest distance between a first pressing area (4111) on the pressing member (41) and the outer diameter of the first deformable pressure-receiving member (42). In Example 4, a deformation or strain of 0.6 mm was measured. The amount of deformation may be greater than or equal to about 0.1 mm, smaller than or equal to about 1.5 mm, and/or between about 0.1 mm and about 1.5 mm. The amount of deformation may be greater than or equal to about 0.3 mm, smaller than or equal to about 1.0 mm, and/or between about 0.3 mm and about 1.0 mm. The amount of deformation may be greater than or equal to about 1 time of the thickness of the image recording medium (5), smaller than or equal to about 12.5 times of the thickness of the image recording medium (5), and/or between about 1 time of the thickness of the image recording medium (5) and about 12.5 times of the thickness of the image recording medium (5). The amount of deformation may be greater than or equal to about 2.5 times of the thickness of the image recording medium (5), smaller than or equal to about 8.3 times of the thickness of the image recording medium (5), and/or between about 2.5 times of the thickness of the image recording medium (5) and about 8.3 times of the thickness of the image recording medium (5). As the image recording medium (5) passed through the first step difference deformation (4221), the image recording medium (5) was bent, a corresponding step difference (56) of 0.6 mm was formed and a high shear effect was exerted on the image recording medium accordingly. The step difference may be greater than or equal to about 0.1 mm, smaller than or equal to about 1.5 mm, and/or between about 0.1 mm and about 1.5 mm. The step difference may be greater than or equal to about 0.3 mm, smaller than or equal to about 1.0 mm, and/or between about 0.3 mm and about 1.0 mm. Not to be bound by theory, but it is believed that the shear effect thus generated facilitated the rupture of the microcapsules in the medium and the subsequent image development even with a significantly lower applied force on the image development device (4).

Referring to FIG. 4A, FIG. 4B and FIG. 4C, the first step feature (411) of the pressing member (41) comprises a first guiding-in area (4110), the first pressing area (4111), a first step area (4112), and a first guiding-out area (4113), and the first deformable pressure-receiving member (42) with a rotation axis (R1). In Example 4, the length of the pressing member (41) along the rotation axis (R1) is 56.5 mm, the length of the first deformable pressure-receiving member (42) along the rotation axis (R1) is 68.6 mm. The hard core (421) and the soft external layer (422) of the first deformable pressure-receiving member (42) are made of a free-cutting steel and a rubber with a Shore hardness (Shore A) of 60°, respectively. The first pressing area (4111) and the first step area (4112) are connected and form a rounded corner with a radius of curvature of 0.2 mm. The radius of curvature may be greater than or equal to about 0.1 mm, smaller than or equal to about 1.2 mm, and/or between about 0.1 mm and about 1.2 mm. The radius of curvature may be greater than or equal to about 0.1 mm, smaller than or equal to about 0.5 mm, and/or between about 0.1 mm and about 0.5 mm. The radius of curvature may be greater than or equal to about 1 time of the thickness of the image recording medium (5), smaller than or equal to about 10 times of the thickness of the image recording medium (5), and/or between about 1 time of the thickness of the image recording medium (5) and about 10 times of the thickness of the image recording medium (5). The radius of curvature may be greater than or equal to about 1 time of the thickness of the image recording medium (5), smaller than or equal to about 4.2 times of the thickness of the image recording medium (5), and/or between about 1 time of the thickness of the image recording medium (5) and about 4.2 times of the thickness of the image recording medium (5). The first step area (4112) and the first guiding-out area (4113) are connected and form an angle, and in Example 2, the angle is 90°. This angle may be less than about 135°. This angle may greater than or equal to about 45°, smaller than or equal to about 120°, and/or between about 45° and about 120°.

As shown in FIG. 4A and FIG. 4B, the first deformable pressure-receiving member (42) comprises an axle center (A1) and an outer diameter (D1). In Example 4, the outer diameter (D1) is 7.6 mm and the first step area (4112) intersects with the first guiding-out area (4113) at a first axis (4114). In particular, the first guiding-out area represents an extension or extending area disposed to intersect with the first step area (4112) at the first axis (4114). In some instances, however, a step area or turn area and an extension thereof do not intersect at an axis. Since both FIG. 4A and FIG. 4B are cross-sectional views of the image development device (4), the first axis (4114) shown therein appears to be a point. The shortest distance between the first axis (4114) and the perpendicular line (L1) passing through the axle center (A1) of the first deformable pressure-receiving member (42) is a first distance (X1). In Example 4, the first distance (X1) is 0.6 mm. The first distance (X1) may be greater than or equal to about 0.1 mm, smaller than or equal to about 1.5 mm, and/or between about 0.1 mm and 1.5 mm. The first distance (X1) may be greater than or equal to about 0.3 mm, smaller than or equal to about 1.0 mm, and/or between about 3 mm and 1.0 mm. The first distance (X1) may be greater than or equal to 1 time of the thickness of the image recording medium (5), smaller than 12.5 times the thickness of the image recording medium (5), and/or between 1 time and 12.5 times the thickness of the image recording medium (5). The first distance (X1) may be greater than or equal to 2.5 times of the thickness of the image recording medium (5), smaller than 8.3 times the thickness of the image recording medium (5), and/or between 2.5 time and 8.3 times the thickness of the image recording medium (5). The first distance (X1) may be greater than or equal to about 0.04 times of the outer diameter (D1), smaller than or equal to about 0.13 times of the outer diameter (D1), and/or between about 0.04 times of the outer diameter (D1) and 0.13 times of the outer diameter (D1). The perpendicular line (L1) of the axle center (A1) refers to a line along the normal direction (Y) of a base (11) of the framework (1) (as shown in FIG. 3A). The shortest vertical distance between the first pressing area (4111) and the axis (4114) or the first guiding-out area (4113) is a second distance (Y1), and in Example 4, the second distance (Y1) is 0.6 mm. The second distance (Y1) may be longer than or equal to about 0.1 mm, shorter than or equal to about 1.5 mm, and/or between about 0.1 mm and 1.5 mm. The second distance (Y1) may be longer than or equal to about 0.3 mm, shorter than or equal to about 1.0 mm, and/or between about 0.3 mm and 1.0 mm. The second distance (Y1) may be between greater than or equal to about 1 time the thickness of the image recording medium (5), smaller than or equal to about 12.5 times the thickness of the image recording medium (5), and/or between 1 time the thickness of the image recording medium (5) and 12.5 times the thickness of the image recording medium (5). The second distance (Y1) may be greater than or equal to about 2.5 times of the thickness of the image recording medium (5), smaller than or equal to about 8.3 times of the thickness of the image recording medium (5), and/or between about 2.5 times of the thickness of the image recording medium (5) and about 8.3 times of the thickness of the image recording medium (5). The second distance (Y1) may be greater than or equal to about 0.01 times of the outer diameter (D1), smaller than or equal to about 0.2 times of the outer diameter (D1), and/or between about 0.01 times of the outer diameter (D1) and about 0.2 times of the outer diameter (D1). The second distance (Y1) may be greater than or equal to about 0.04 times of the outer diameter (D1), smaller than or equal to about 0.13 times of the outer diameter (D1), and/or between about 0.04 times of the outer diameter (D1) and about 0.13 times of the outer diameter (D1).

### Effect of the Step Feature on Image Quality

Taking what is illustrated in FIG. 2, FIG. 3B, FIG. 4A, and FIG. 4B as examples, when the image recording medium (5) passes through the image development device (4), the first step feature (411) in the image development device (4) causes the image recording medium (5) to bend and form a corresponding step difference (56) which may generate four different types of stress effects, namely, normal stress, friction shear stress, internal bending normal stress, and internal bending stress. All these stresses significantly help rupture the microcapsules (531) inside the image recording medium (5) and improve image quality, including, for example, one or more of the color density, Dₘₐₓ, color saturation, color uniformity, rate of image development and D_{max,fresh}.

The normal stress may be caused by the normal force (perpendicular to the feeding direction (F)), exerted on the surface of the image recording medium (5) by the first step feature (411) and the first deformable pressure-receiving member (42). The friction shear stress may be caused jointly by two forces, namely, (a) the friction force between the first pressing area (4111) of the first step feature (411) and the top contact surface of the image recording medium (5), and (b) the driving force by the first deformable pressure-receiving member (42).

When the image recording medium (5) passes through the first step feature (411), due to the bending of the image recording medium (5), an internal shear stress may appear substantially in the direction parallel to the feeding direction (F) of the image recording medium (5) with the maximum internal shear stress τₘₐₓ at the neutral axis of the image recording medium 5.

Not to be bound by theory, it is believed that as compared to the traditional compression-roller or rolling-ball types of image development devices, the image development device of Example 4 comprising the step difference (56) may generate additional shear stresses including the internal bending normal stress and internal shear stress. As a result, the microcapsules (531) inside the image recording medium (5) may be ruptured more easily and uniformly to result in images of improved quality.

### Example 5 Another Image Development Device (4a)

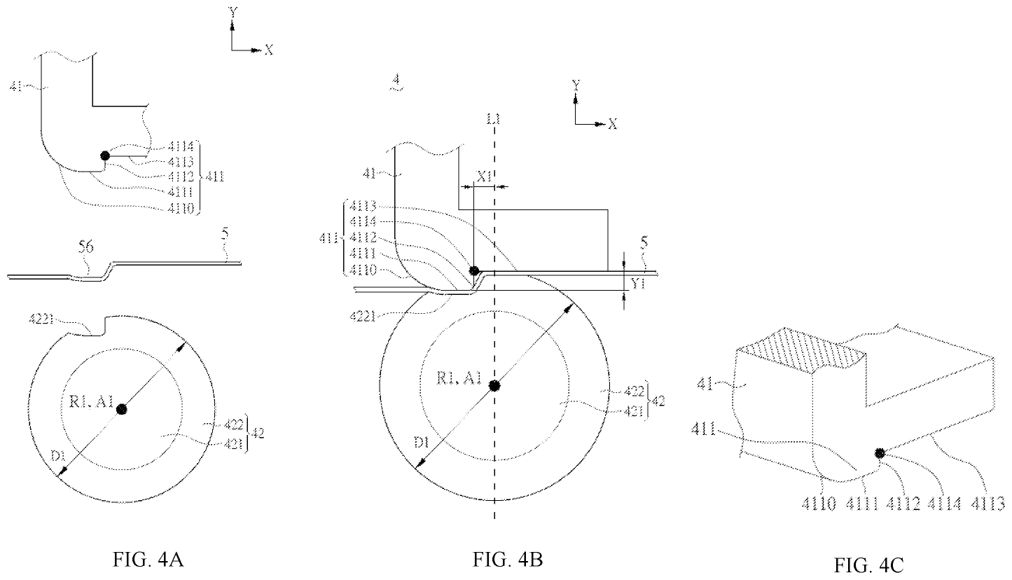

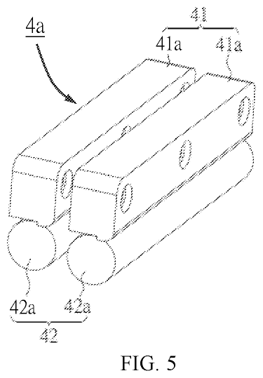

FIG. 5 is a schematic view of another image development device (4a) assembled according to Example 5. As shown in FIG. 5, the image development device (4a) comprises two sub-sets of pressing member (41a) and deformable pressure-receiving member with the first pressing member (41a) and the second pressing member (41a) in contact with the first deformable pressure-receiving member (42a) and the second deformable pressure-receiving member (42a), respectively.

### Example 6 Another Imaging Apparatus (100b)

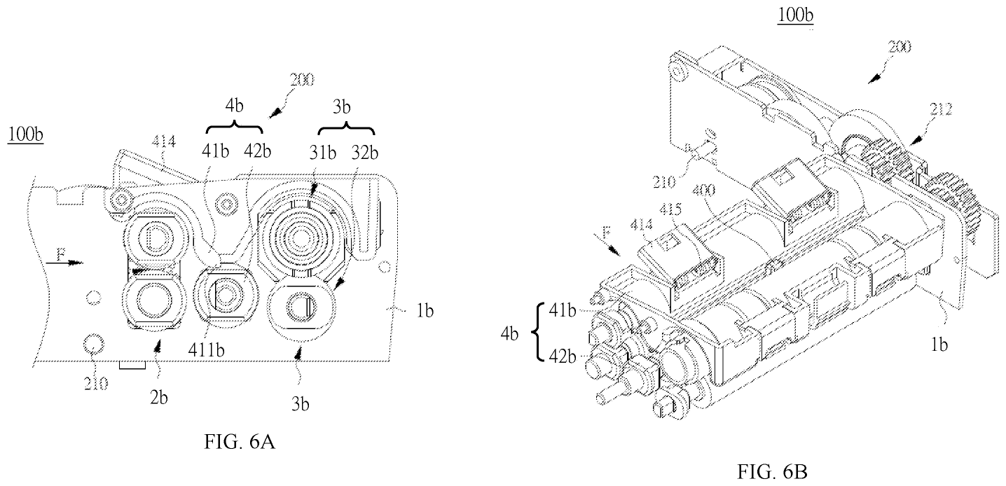

FIG. 6A is a side view of another imaging apparatus (100b) assembled according to Example 6, and FIG. 6B is the schematic isometric view of FIG. 6A. The imaging apparatus (100b) comprises a feeding device (2b), an image development device (4b), and a heating device (3b) (e.g., a heater). As shown in FIG. 6A and FIG. 6B, the imaging apparatus (100b) comprises a framework (1b) and a power subassembly (200). The power subassembly (200) comprises a feeding device (2b), a heating device (3b), and an image development device (4b), wherein the feeding device (2b), the heating device (3b), and the image development device (4b) were assembled onto the framework (1b). The image development device (4b) comprising a pressing member (41b) and a first deformable pressure-receiving member (42b) was disposed between the feeding device (2b) and the heating device (3b). The pressing member (41b) was provided with a first step feature (411b), a spring support member (414), and a torsion spring (415) which supports the spring support member (414) on the framework (1b), such that the pressing member (41b) presses downward against the first deformable pressure-receiving member (42b), to cause the microcapsules (531) inside the photosensitive microcapsule layer (53) to rupture.

Referring to FIG. 1 at the same time, the power subassembly (200) shown in FIG. 6A and FIG. 6B was constructed to transport the image recording medium (5) to pass through the image development device (4b). Specifically, the power subassembly (200) transports the image recording medium (5) along the feeding direction (F). The power subassembly (200) which comprises a support member (labeled as the framework (1b) in FIG. 6A and FIG. 6B), and the feeding device (2b), the image development device (4b), and the heating device (3b) were connected to the framework (1b). The framework (1b) may be detachable to allow the power subassembly (200) to be selectively and easily removed from the imaging apparatus (100b) to facilitate assembly and/or maintenance.

Referring to FIG. 1 at the same time, the power subassembly (200) comprises an input shaft (210) rotatably connected to the framework (1b). The power subassembly (200) further comprises a power transmission device (labeled as a gear train (212) in FIG. 6A and FIG. 6B), which comprises a series of mutually engaged power transmission elements or gears. Gears of the gear train (212) were connected to the input shaft (210), the feeding device (2b), the image development device (4b), and the heating device (3b). The input shaft (210) was constructed to transfer and allocate rotation mechanical energy from the input shaft (210) to the feeding device (2b), the image development device (4b), and the heating device (3b). As such, a single motor (10) may be used to drive the feeding device (2b), the image development device (4b), and the heating device (3b), and to transport the image recording medium (5) from the sheet tray (9) through the image development device (4b) and the heating device (3b), and out of the imaging apparatus (100b).

In addition, referring to FIG. 1 at the same time, the heating device (3b) comprises a heating element (31b) and a third deformable pressure-receiving member (32b). In Example 6, a heating roller was used as the heating element (31b). By way of example, the heating element (31b) may be a heating sheet, a heating film, a heating panel, or a heating roller. The image recording medium (5) moves sequentially through the feeding device (2b), the image development device (4b), and the heating device (3b). The temperature of the heating element (31b) was set at 70° C. in Example 6. The temperature of the image recording medium (5) may be controlled relatively consistently throughout the development process by the heating element (31b) to facilitate a consistent reaction rate between the leuco dyes and the dye developer as well as a consistent diffusion or spreading of the dyes in the image recording medium, thereby resulting in improvements in the rate of image development and the image quality.

### Example 7 A Heating Device (3c) with a Heating Element (31c) Having a Step Feature

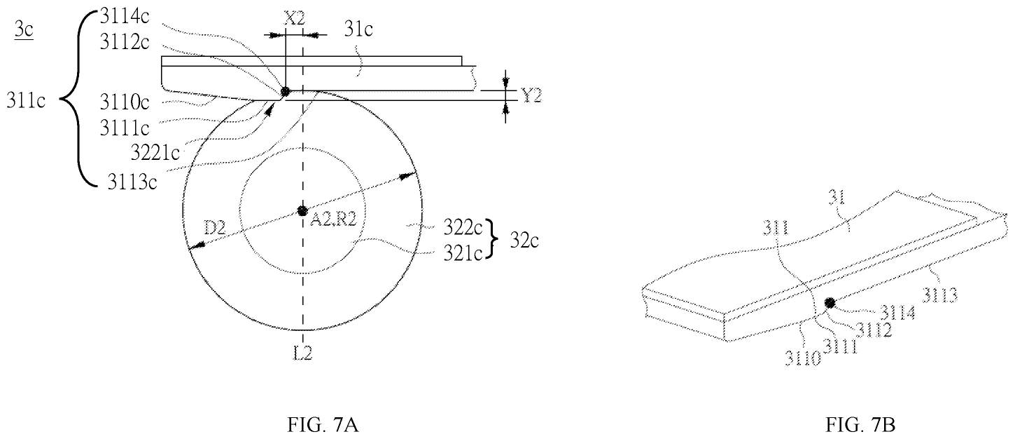

FIG. 7A shows a schematic view of a heating device (3c) assembled according to Example 7 with a heating element (31c) having a third step feature (311c), and FIG. 7B is a 3-dimensional schematic view of the heating element (31c) of the heating device (3c).

As shown in FIG. 7A, a heating element (31c) having a step feature (311c) was employed in the heating device (3c). The third step feature generates a third step difference deformation (3221c) with a deformation of about 0.4 mm. As an image recording medium (5) passes through between the heating element (31c) and the third deformable pressure-receiving member (32c), the image recording medium (5) is not only heated, but also bent to generate a shear effect, so as to facilitate a faster and more uniform image development with a better image quality. The third step feature (311c) comprises a third guiding-in area (3110c), a third pressing area (3111c), a third step area (3112c), and a third guiding-out area (3113c). The third deformable pressure-receiving member (32c) rotates about a rotation axis (R2).

In Example 7, the heating device (3c) comprises a heating element (31c) and a third deformable pressure-receiving member (32c). The length of the heating element (31c) along the rotation axis (R2) was set to be 53 mm, the heating set temperature was 70° C., and the length of the third deformable pressure-receiving member (32c) along the rotation axis (R2) was 68.6 mm. The hard core (321c) is made of a free-cutting steel, and the soft external layer (322c) is made of a rubber with a Shore hardness (Shore A) of 60°.

In Example 7, the third deformable pressure-receiving member (32c) comprises an axle center (A2) and an outer diameter (D2) of about 7.6 mm. The third step area (3112c) and the third guiding-out area (3113c) were connected at a third axis (3114c) which appears as a point in the cross-sectional view (FIG. 7A). The shortest distance between the third axis (3114c) and the perpendicular line (L2) passing through the axle center (A2) of the third deformable pressure-receiving member (32c) is a third distance (X2) which was set to be 0.6 mm. The perpendicular line (L2) of the axle center (A2) refers to a line along the normal direction (Y) of the base (11) of the framework (1) (as shown in FIG. 3A). The shortest vertical distance between the third pressing area (3111c) and the axis (3114c) or the third guiding-out area (3113c) is a fourth distance (Y2), and in the present example, the fourth distance (Y2) was set to be 0.4 mm.

### Example 8 Image Development Device (4d) with a Second Step Feature (413d)

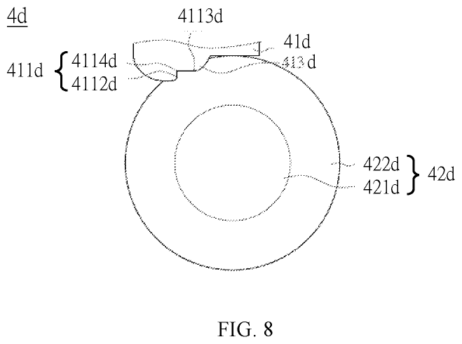

FIG. 8 shows a schematic view of another image development device (4d) built according to Example 8. As it can be seen in FIG. 8, the image development device (4d) is similar to the image development device (4) built in Example 4 except that the pressing member (41d) of the image development device (4d) was provided with an additional second step feature (413d) to further increase the number of ruptured microcapsules (531) and the degree of rupture, and thereby improve the image quality. Here, a step feature (411d) similar to that of the first step feature of Example 4 was employed as the second step feature (413d).

### Example 9 Image Development Devices Comprising a Plurality of Pressing Members and Deformable Pressure-Receiving Members

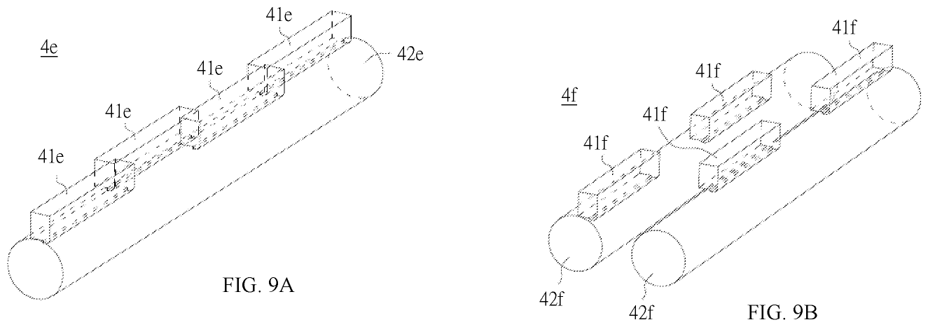

FIG. 9A and FIG. 9B show schematic views of another two image development devices (4e and 4f, respectively) built according to Example 9. Unlike the image development device (4) demonstrated in Example 3 (as shown FIG. 3B) in which only a pressing member and a deformable pressure-receiving member were used, the image development devices (4e and 4f) of Example 9A and Example 9B, respectively comprise a plurality of pressing members and deformable pressure-receiving members assembled differently in the devices. As shown in FIG. 9A, four pressing members (41e) are coaxially placed on a deformable pressure-receiving member (42e) in the image development device (4e) of Example 9A. In contrast, in the image development device (4f) of Example 9B as shown in FIG. 9B, four pressing members (41f) are staggered on two pressure-receiving members (42f).

### Example 10 Image Development Device with a Conveyor or a Belt (424) as the Deformable Pressure-Receiving Member (4g)

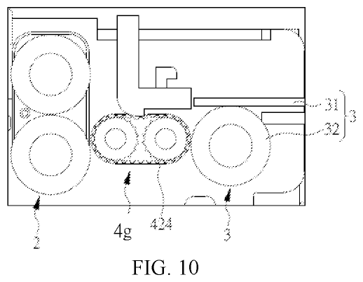

FIG. 10 shows a schematic view of an image development device (4g) comprising a deformable conveyor or belt (424) as the deformable pressure-receiving member. Also included in the assembly of FIG. 10 are a feeding device (a feeding module, a feeder) (2) and a heating device (3). In one embodiment, the conveyor or belt is replaced with an elastic transporting element, for example, a rubber rotation shaft, such that the deformable pressed member is a transporting element.

### Example 11 Effect of the Step Feature on the Fresh Maximum Optical Density (D_{max,fresh})

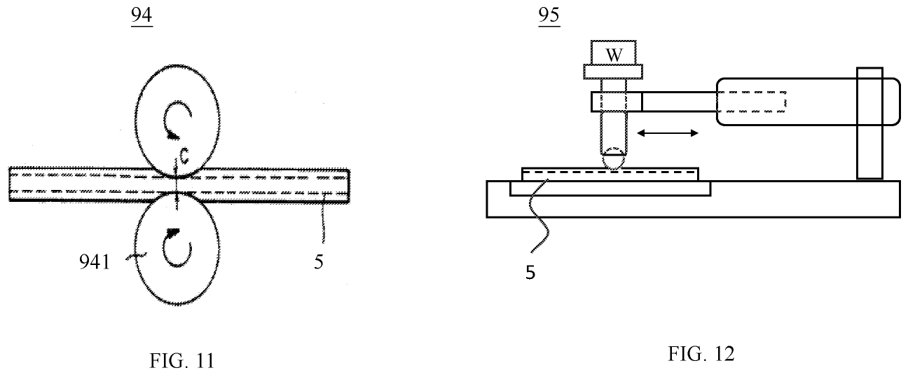

The image recording medium (5) of Example 2 was developed with the image development device (4) of Example 4 of the present disclosure (as shown in FIG. 4A and FIG. 4B) and the roller-type development device of the Comparative Example (FIG. 11). Various deformation or strain (from 0 mm to 0.9 mm) of the first deformable pressure-receiving member (42) were induced with various applied force from 1.6 kg to 24.0 kg. The fresh maximum optical density (D_{max,fresh}) of the image recording medium (5) as measured by a reflective Spectrodensitometer FD-5 from Konica Minolta immediately after the development is summarized in Table 4.

TABLE 4
The effect of the step feature and the applied force on the D_{max, fresh}

| | | Deformation or Starin of | | | |
|---|---|---|---|---|---|
| | Step Feature of | the First Deformable | | | Fresh Maximum |
| | The Pressing | Pressure-Receiving | Applied | | Optical Density |
| Example 11 | Member | Member Due To The Step | Force | | (D_{max, fresh}) |
| 11-0 | No | None | 24.0 | kg | 0.60 |
| (Comparative | | | | | |
| Example) | | | | | |
| 11-1 | Yes | 0.2 mm | 1.6 | kg | 0.37 |
| 11-2 | | 0.3 mm | 2.4 | kg | 0.60 |
| 11-3 | | 0.4 mm | 3.6 | kg | 0.68 |
| 11-4 | | 0.5 mm | 4.3 | kg | 0.82 |
| 11-5 | | 0.6 mm | 6.0 | kg | 0.89 |
| 11-6 | | 0.9 mm | 13.5 | kg | 1.03 |

In the Comparative Example 11-0, the image recording medium was developed with a Conventional roller-type image development device (94) without any step feature as shown in FIG. 11. The applied normal force on the roller is 24 Kg. As such, essentially no or little shear stress may be exerted on the image recording medium during the image development process.

As can be seen from Table 4 that, the image recording media developed by the image development device with the step feature of Example 4 show a significantly higher D_{max,fresh} than the one developed by the conventional roller-type of development device of the comparative Example even at a significantly lower applied force. At an applied force of only 2.4 Kg, the D_{max,fresh} of the medium developed by the development device of Example 4 can reach about the same level (0.6) as the one developed by the Comparative Example 11-0 with an applied force of 24.0 Kg. In other words, about the same fresh optical density can be obtained by the development device of Example 4 of the present disclosure with a 10 times less applied force than the one developed by a conventional roller-type of development device without a step feature. The D_{max,fresh} of the samples developed by the image development device of Example 4 increases further with an increasing applied force and a D_{max,fresh} of 1.03 can be obtained with an applied force of only 13.5 Kg. In summary, an impressive increase in D_{max,fresh} (from 0.6 to 1.03, an increase of about 71.7%) can be achieved with the image development device of Example 4 of the present disclosure with an about 56% less applied force (13.5 Kg vs. 24.0 Kg) than the one developed with the Comparative Example 11-0. It is evident from Table 4 that images of a significantly higher fresh optical density and color saturation can be achieved by the image development device of Example 4 even with a significantly reduced applied force.

In general, the image quality of a developed image may be characterized by the graininess and mottle of the developed images of comparable D_{max,fresh} (such as Comparative Examples 11-0, 11-2 and 11-3). The lower the degree of graininess and mottle, the better the image quality may be perceived by the users. In Example 11, all the images were scanned by the Perfection V850 Pro scanner from Epson, and the graininess and mottle were measured by an automated print quality analysis system (QEA, IAS-2000D). As it can be seen from Table 5 that, at a comparable D_{max,fresh}, both the degree of graininess and mottle of the images developed by the image development device of Example 4 with the step feature of the present disclosure are significantly lower than those of the images developed by Comparative Example 11-0.

TABLE 5
Graininess and Mottle of the Developed
Images of Examples 11-0, 11-2, 11-3

| | Fresh Maximum | | |
|---|---|---|---|
| Example 11 | Optical Density | Graininess | Mottle |
| 11-0 | 0.60 | 0.09 | 0.10 |
| (Comparative | | | |
| Example) | | | |
| 11-2 | 0.60 | 0.07 | 0.04 |
| 11-3 | 0.68 | 0.05 | 0.04 |

### Example 12 Effect of Post Heating by a Heating Device on D_{max,fresh}

The image recording media of Example 2 was developed by the imaging apparatus (100) of Example 3 (FIG. 3A) equipped with a heating sheet disposed immediately after the image development device to post heat the ruptured image media at 70° C., 80° C. and 90° C. A deformation of 0.6 mm was set for the first deformable pressure-receiving member (42). The D_{max,fresh} of the developed image recording media is summarized in Table 6.

TABLE 6
Effect of post-heating

| | Deformation of The | | |
|---|---|---|---|
| | First Deformable | Set temperature | Fresh Maximum |
| | Pressure- | of The | Optical Density |
| Example 12 | Receiving Member | Heating Sheet | (D_{max, fresh}) |
| 12-0 | 0.6 mm | No heating | 0.89 |
| (Comparative | | | |
| Example ) | | | |
| 12-1 | 0.6 mm | 70° C. | 1.21 |
| 12-2 | 0.6 mm | 80° C. | 1.45 |
| 12-3 | 0.6 mm | 90° C. | 1.65 |

As can be seen from Table 6, the D_{max,fresh} can be effectively increased with an increasing post-heating temperature set for the heating sheet.

### Example 13 Effect of the Step Difference of the Pressing Member on D_{max,fresh}

The imaging apparatus (100) of Example 3 (as shown in FIG. 3A) and the image recording medium (5) of Example 2 were used. Both the first distance X1 and the second distance Y1 of the first step feature of the pressing member 41 on the image development device (4) were set between 0.4 mm and 1.0 mm. A heating sheet was used as the heating element (31) with the temperature set at 70° C. The D_{max,fresh} of the thus developed image recording media is summarized in Table 7.

TABLE 7
Effect of the step difference of the pressing member

| | First | First | Fresh Maximum |
|---|---|---|---|
| Example 13 | distance X1 | distance Y1 | Optical Density |
| 11-0 | N/A (no step | N/A (no step | 0.60 |
| (Comparative | difference | difference | |
| Example) | feature) | feature) | |
| 13-1 | 0.4 mm | 0.4 mm | 1.01 |
| 13-2 | 0.4 mm | 0.6 mm | 1.09 |
| 13-3 | 0.4 mm | 0.8 mm | 1.10 |
| 13-4 | 0.4 mm | 1.0 mm | 1.12 |
| 13-5 | 0.6 mm | 0.4 mm | 1.13 |
| 13-6 | 0.6 mm | 0.6 mm | 1.24 |
| 13-7 | 0.6 mm | 0.8 mm | 1.24 |
| 13-8 | 0.6 mm | 1.0 mm | 1.24 |
| 13-9 | 0.8 mm | 0.4 mm | 1.08 |
| 13-10 | 0.8 mm | 0.6 mm | 1.16 |
| 13-11 | 0.8 mm | 0.8 mm | 1.20 |
| 13-12 | 0.8 mm | 1.0 mm | 1.21 |
| 13-13 | 1.0 mm | 0.4 mm | 1.02 |
| 13-14 | 1.0 mm | 0.6 mm | 1.12 |
| 13-15 | 1.0 mm | 0.8 mm | 1.14 |
| 13-16 | 1.0 mm | 1.0 mm | 1.18 |

As can be seen from Table 7, the D_{max,fresh} in all Examples developed with an image development device with a step feature (Examples 13-1 to 13-16) are significantly higher than that of Comparative Example 11-0. In addition, it appears that the optimal range for both the first distance X1 and the second distance Y1 is between about 0.6 mm and about 0.8 mm. Not to be bound by theories, it is believed that an optimal bending and shear effect on the image recording medium may be achieved with the first distance X1 and the second distance Y1 set within this range, which leads to a high D_{max,fresh}.

### Example 14 Effect of Heating Element Having a Step Feature on D_{max,fresh}

An image apparatus (100) comprising an image development device (4) as shown in FIGS. 3A and 3B, and a heating device (3c) of Example 7 as shown in FIG. 7A was used to develop the image recording medium of Example 2. The deformation of the first deformable pressure-receiving member (42) of the image development device (4) was set at 0.6 mm. The deformation of the third deformable pressure-receiving member (32c) of the heating device (3c) was set at 0.4 mm, 0.6 mm, and 0.8 mm for Examples 14-1, 14-2 and 14-3, respectively. In contrast, the heating device of the Comparative Example 14-0 was equipped with a heating element without any step feature. In all the cases of Example 14, the temperature of the heating element was set at 70° C. The results of D_{max,fresh} of the developed image recording media are summarized in Table 8.

TABLE 8
Effect of a heating element having a step feature

| | Step | Deformation of the | |
|---|---|---|---|
| | difference of | assembled third | Fresh Maximum |
| | the heating | deformable pressure- | Optical Density |
| Example 14 | element | receiving member | (D_{max, fresh}) |
| 14-0 | No | None | 1.21 |
| (Comparative | | | |
| Example) | | | |
| 14-1 | Yes | 0.4 mm | 1.60 |
| 14-2 | | 0.6 mm | 1.62 |
| 14-3 | | 0.8 mm | 1.70 |

As can be seen from Table 8, compared with Comparative Example 14-0, the medium developed by the image apparatus equipped with a heating element (31c) with a step feature showed a significantly higher D_{max,fresh}. And, the D_{max,fresh} increases with increasing deformation of the third deformable pressure-receiving member (32c) of the heating device.

### Example 15 Effect of the Image Development Device (4) on Noise

In Example 15-1, the image development device of Example 4 (as shown in FIG. 4B) was used to develop the imaging recording medium of Example 2. The maximum noise level produced during the image development process was measured by a Tenmars TM-102 sound level meter. The result is shown in Table 9. Also shown are the noise levels detected during the image development by two comparative devices 15-0-1 and 15-0-2. In Comparative Example 15-0-1, a rolling-ball type of image development device (95) as shown in FIG. 12 was used. It comprises a single rolling-ball (diameter 9.0 mm) moving back-and-forth at a speed of 52.8 mm/sec under a normal applied force of 1.5 Kg. As such, the image recording medium (5) was pressed tightly by the rolling-ball with a normal pressure about the same as that applied by the image development device of Example 15-1. In Comparative Example 15-0-2, the compression-roller type of image development device used in Example 11-0 (FIG. 11) was used. It is evident that the imaging development device of the present disclosure can produce a similar or higher D_{max,fresh} with a significantly lower maximum noise level during the development process than those produced by the two comparative image development devices. A significantly lower level of vibration was also observed during the image development in Example 15-1 as compared to the two comparative devices.

TABLE 9
The maximum noise level detected
during image development process.

| | Type of Image | | Fresh Maximum |
|---|---|---|---|
| | Development | Maximum Noise | Optical Density |
| Example 15 | Device Used | Detected (dB) | (D_{max, fresh}) |
| 15-0-1 | Rolling-ball | 90 | 0.43 |
| (Comparative | (As shown in | | |
| Example) | FIG. 12) | | |
| 15-0-2 | Compression | 83 | 0.60 |
| (Comparative | Roller (As | | |
| Example) | shown in | | |
| | FIG. 11) | | |
| 15-1 | Step Feature | 64 | 0.60 |
| | of Example 4 | | |
| | (As shown in | | |
| | FIG. 4B) | | |

In summary, the image development devices of the present disclosure can effectively produce high quality images with a significantly higher fresh optical density (D_{max,fresh}), higher color saturation, and lower noise level and vibration during the image development process with a significantly lower applied pressure. The devices and methods of the present disclosure enabled a high quality, low cost, light weight, low noise and low vibration, compact and portable imaging apparatus. While the present invention has been described herein through a plurality of embodiments and experiments, those skilled in the art should understand that the inventive concepts herein are not only limited to the disclosed embodiments or details. These embodiments may include a description of best modes and/or preferred embodiments, and many other possible modifications and variations may be made as long as they do not depart from the spirit of the present invention and what is claimed by the appended claims.

[Description of legends]

| | |
|---|---|
| 1, 1b | framework |
| 11 | base |
| 100, 100b | imaging apparatus |
| 2, 2b | feeding device |
| 200 | power subassembly |
| 210 | input shaft |
| 212 | gear train |
| 3, 3b, 3c | heating device |
| 31, 31b, 31b c | heating element |
| 311, 311c | third step feature |
| 3110, 3110c | third guiding-in area |
| 3111, 3111c | third pressing area |
| 3112, 3112c | third step area |
| 3113, 3113c | third guiding-out area |
| 3114, 3114c | third axis |
| 32, 32b, 32c | third deformable pressure-receiving member |
| 321, 321c | hard core |
| 322, 322c | soft external layer |
| 3221c | third step difference deformation |
| 4, 4a, 4b, 4d, 4e, | image development device |
| 4f, 4g | |
| 41, 41a, 41b, 41e, | pressing member |
| 41f, 41g, 941 | |
| 411, 411b | first step feature |
| 4110 | first guiding-in area |
| 4111 | first pressing area |
| 4112 | first step area |
| 4113 | first guiding-out area |
| 4114 | first axis |
| 413d | second step feature |
| 414 | spring support member |
| 415 | torsion spring |
| 42, 42a , 42b, 42d, | deformable pressure-receiving member |
| 42e, 42f | |
| 421, 421d | hard core |
| 422, 422d | soft external layer |
| 4221, 4221d | first step difference deformation |
| 424 | soft transporting element |
| 5 | image recording medium |
| 51 | substrate |
| 52 | surface treatment layer |
| 53 | photosensitive microcapsule layer |
| 531 | microcapsules |
| 53a | unhardened |
| 53b | partially hardened |
| 53c | fully hardened |
| 54 | dye developer layer |
| 55 | top layer |
| 56 | corresponding step difference |
| 6 | exposure device |
| 61 | exposure limiter |
| 62 | lens array |
| 63 | exposure light source |
| 9 | sheet tray |
| 94 | conventional roller image development device |
| 10 | motor |
| 12 | controller |
| 121 | processor |
| 122 | memory |
| 13 | power source |
| 14 | user interface |
| A1, A2 | axle center |
| D1, D2 | outer diameter |
| F | feeding direction |
| L | light |
| L1, L2 | perpendicular line |
| R | radius of curvature |
| R1, R2 | rotation axis |
| T | total thickness of image recording medium |
| X | direction |
| X1 | first distance |
| X2 | third distance |
| Y | direction |
| Y1 | second distance |
| Y2 | fourth distance |

1. A image development device for an image recording medium, comprising:
at least one pressing member; and
at least one deformable pressed member,
the at least one pressing member and the at least one deformable pressed member configured to permit the image recording medium to pass therebetween, and
the at least one pressing member having a step difference feature and configured to apply a pressure on the at least one deformable pressed member, such that the image recording medium, when passing between the pressing member and the deformable pressed member, is bent.

2. The image development device for an image recording medium according to claim 1, wherein the applied pressure is positive pressure.

3. The image development device for an image recording medium according to claim 1, wherein the at least one pressing member comprises a first pressing member and a second pressing member, the at least one deformable pressed member comprises a first deformable pressed member and a second deformable pressed member, and the first pressing member and the second pressing member are in contact with the first deformable pressed member and the second deformable pressed member, respectively.

4. The image development device for an image recording medium according to claim 1, wherein the image recording medium is a pressure-sensitive image recording medium.

5. The image development device for an image recording medium according to claim 4, wherein the pressure-sensitive image recording medium is a radiation-sensitive, pressure-sensitive image medium.

6. The image development device for an image recording medium according to claim 5, wherein the radiation-sensitive pressure-sensitive image medium is a microcapsule-based photosensitive image recording medium.

7. The image development device for an image recording medium according to claim 1, wherein the step difference feature comprises one of a pressing area, a step area, or a guiding-out area.

8. The image development device for an image recording medium according to claim 7, wherein the step area and an extending area of the step area intersect at an axis.

9. The image development device for an image recording medium according to claim 7 or claim 8, wherein the shortest distance between the step area or the axis and a perpendicular line passing through the axle center of the first deformable pressed member is a first distance, the first distance being (i) between greater than or equal to about 0.1 mm and smaller than or equal to about 1.5 mm, or (ii) between greater than or equal to about 1 time of the thickness of the image recording medium and smaller than or equal to about 12.5 times of the thickness of the image recording medium.

10. The image development device for an image recording medium according to claim 7 or claim 8, wherein the shortest distance between the step area or the axis and a perpendicular line passing through the axle center of the first deformable pressed member is a first distance, the first distance being between greater than or equal to about 0.3 mm and smaller than or equal to about 1.0 mm.

11. The image development device for an image recording medium according to claim 7 or claim 8, wherein the shortest distance between the step area or the axis and a perpendicular line passing through the axle center of the first deformable pressed member is a first distance, and the image recording medium has a thickness, the first distance being between greater than or equal to about 2.5 times of the thickness and smaller than or equal to about 8.3 times of the thickness.

12. The image development device for an image recording medium according to claim 7 or claim 8, wherein the shortest distance between the step area or the axis and a perpendicular line passing through the axle center of the deformable pressed member is a first distance, and the deformable pressed member has an outer diameter, the first distance being between greater than or equal to about 0.01 times of the outer diameter and smaller than or equal to about 0.2 times of the outer diameter.

13. The image development device for an image recording medium according to claim 7 or claim 8, wherein the shortest distance between the step area or the axis and a perpendicular line passing through the axle center of the deformable pressed member is a first distance, and the deformable pressed member has an outer diameter, the first distance being between greater than or equal to about 0.04 times of the outer diameter and smaller than or equal to about 0.13 times of the outer diameter.

14. The image development device for an image recording medium according to claim 7 or claim 8, wherein the shortest vertical distance between the guiding-out area or the axis and the pressing area is a second distance, and the second distance is (i) between longer than or equal to about 0.1 mm and shorter than or equal to about 1.5 mm, or (ii) between greater than or equal to about 1 time of the thickness of the image recording medium and smaller than or equal to about 12.5 times of the thickness of the image recording medium.

15. The image development device for an image recording medium according to claim 7 or claim 8, wherein the shortest vertical distance between the guiding-out area or the axis and the pressing area is a second distance, and the second distance is between longer than or equal to about 0.3 mm and shorter than or equal to about 1.0 mm.

16. The image development device for an image recording medium according to claim 7 or claim 8, wherein the shortest vertical distance between the guiding-out area or the axis and the pressing area is a second distance, and the image recording medium has a thickness, the second distance being between greater than or equal to about 2.5 times of the thickness and smaller than or equal to about 8.3 times of the thickness.

17. The image development device for an image recording medium according to claim 7 or claim 8, wherein the shortest vertical distance between the guiding-out area or the axis and the pressing area is a second distance, and the deformable pressed member has an outer diameter, the second distance being between greater than or equal to about 0.01 times of the outer diameter and smaller than or equal to about 0.2 times of the outer diameter.

18. The image development device for an image recording medium according to claim 7 or 8, wherein the shortest vertical distance between the guiding-out area or the axis and the pressing area is a second distance, and the deformable pressed member has an outer diameter, the second distance being between greater than or equal to about 0.04 times of the outer diameter and smaller than or equal to about 0.13 times of the outer diameter.

19. The image development device for an image recording medium according to claim 7 or 8, wherein the step area and the guiding-out area are connected to form an angle, and the angle is no greater than about 135°.

20. The image development device for an image recording medium according to claim 7 or 8, wherein the step area and the guiding-out area are connected to form an angle, and the angle is between greater than or equal to about 45° and smaller than or equal to about 120°.

21. The image development device for an image recording medium according to claim 7 or 8, wherein the step area and the guiding-out area are connected to form an angle, and the angle is equal to about 90°.

22. The image development device for an image recording medium according to claim 7 or 8, wherein the connection between the pressing area and the step area has a rounded corner, the rounded corner has a radius of curvature, and the radius of curvature is between (i) greater than or equal to about 0.1 mm and smaller than or equal to about 1.2 mm, or between (ii) greater than or equal to about 1 time of the thickness of the image recording medium and smaller than or equal to about 10 times of the thickness of the image recording medium.

23. The image development device for an image recording medium according to claim 7 or 8, wherein the connection between the pressing area and the step area has a rounded corner, the rounded corner has a radius of curvature, and the radius of curvature is between greater than or equal to about 0.1 mm and smaller than or equal to about 0.5 mm.

24. The image development device for an image recording medium according to claim 7 or 8, wherein the connection between the pressing area and the step area has a rounded corner, the rounded corner has a radius of curvature, and the image recording medium has a thickness, the radius of curvature being between greater than or equal to about 1 time of the thickness and smaller than or equal to about 4.2 times of the thickness.

25. The image development device for an image recording medium according to claim 1, wherein as assembled, the first deformable pressed member is pressed by the pressing member to form a corresponding amount of deformation, and the amount of deformation is (i) between greater than or equal to about 0.1 mm and smaller than or equal to about 1.5 mm, or (ii) between greater than or equal to about 1 time of the thickness of the image recording medium and smaller than or equal to about 12.5 times of the thickness of the image recording medium.

26. The image development device for an image recording medium according to claim 1, wherein after being assembled, the first deformable pressed member is pressed by the pressing member to form a corresponding amount of deformation, and the amount of deformation is between greater than or equal to about 0.3 mm and smaller than or equal to about 1.0 mm.

27. The image development device for an image recording medium according to claim 1, wherein after being assembled, the first deformable pressed member is pressed by the pressing member to form a corresponding amount of deformation, and the image recording medium has a thickness, the amount of deformation being between greater than or equal to about 2.5 times of the thickness and smaller than or equal to about 8.3 times of the thickness.

28. The image development device for an image recording medium according to claim 1, wherein the image recording medium is bent and forms a step and the step difference is between greater than or equal to about 0.1 mm and smaller than or equal to about 1.5 mm.

29. The image development device for an image recording medium according to claim 1, wherein the image recording medium is bent and forms a step and the step difference is between greater than or equal to about 0.3 mm and smaller than or equal to about 1.0 mm.

30. The image development device for an image recording medium according to claim 1, wherein the pressing member comprise a plurality of pressing members, and the plurality of pressing members are arranged coaxially or arranged to be staggered.

31. The image development device for an image recording medium according to claim 1, wherein the first deformable pressed member is a transporting element.

32. A imaging apparatus, comprising:
at least one feeding module configured to move an image recording medium; and
an image development device arranged downstream of the at least one feeding module and comprising at least one pressing member and at least one deformable pressure-receiving member, the pressing member comprising a step feature and configured to press on the deformable pressure-receiving member, such that the image recording medium, when passing between the pressing member and the deformable pressure-receiving member, is bent.

33. The imaging apparatus according to claim 32, further comprising at least one heating device.

34. The imaging apparatus according to claim 33, wherein the heating device is arranged downstream of the image development device.

35. The imaging apparatus according to claim 33, wherein the heating device comprises at least one heating element and at least one third deformable pressure-receiving member.

36. The imaging apparatus according to claim 33, wherein the heating element is a heating sheet, a heating film, a heating panel, or a heating roller.

37. The imaging apparatus according to claim 33, wherein the heating element comprises at least one step feature.

38. The imaging apparatus according to claim 32, wherein the imaging apparatus further comprises an exposure unit.

39. The imaging apparatus according to claim 32, wherein the imaging apparatus is a printer, a copier, an instant camera, or any combination thereof.

40. A method for forming an image on an image recording medium utilizing a image development device, the image development device comprising at least one pressing member and at least one deformable pressure-receiving member, the at least one pressing member having a step feature and configured to apply pressure on the at least one deformable pressure-receiving member, such that the image recording medium, when passing between the pressing member and the deformable pressure-receiving member, is bent, the method comprising:
image-wise exposing the image recording medium to a light or radiation; and
moving the exposed image recording medium to pass through the image development device, and forming the corresponding image.
